(19) United States
(12) Patent Application Publication
(10) Pub. No.: US 2009/0245179 A1
(43) Pub. Date: Oct. 1, 2009

(54) Method and System for Processing International Calls Using a Voice Over IP Process

(76) Inventors: Jing Liu, Mountain View, CA (US); Xiaolei Qin, San Jose, CA (US)

Correspondence Address: MORGAN, LEWIS & BOCKIUS, LLP. (PA), 2 PALO ALTO SQUARE, 3000 EL CAMINO REAL, SUITE 700, PALO ALTO, CA, 94306, US

(21) Appl. No.: 12/422,822

(22) Filed: Apr. 13, 2009

Related U.S. Application Data
(63) Continuation of application No. 11/248,071, filed on Oct. 11, 2005, now abandoned.
(60) Provisional application No. 60/618,499, filed on Oct. 12, 2004.

(51) Int. Cl. H04W 76/02; H04L 12/66

(52) U.S. Cl. 370/328; 370/352

(57) ABSTRACT

A method for processing an multi-country international phone call, free from an international toll charge, using a voice over IP (VoIP) call from a first mobile handset to a second handset. The method includes transferring destination number information associated with a destination number within a first country code from the first mobile handset to a data network, which is coupled to a world wide network of computers. In a preferred embodiment, the handset is coupled via cellular network through a data network to the world wide network of computers. The method includes transferring caller number information associated with a caller number within a second country code from the first mobile handset to the data network. In a preferred embodiment, the second country code is different from the second country code. The method includes receiving the destination information at a call server process, which is coupled to the world wide network of computers. The method also includes receiving the caller number information at the call server process. The method initiates a first VoIP phone call using the caller number information from the server process to the first mobile handset. The method initiates a second VoIP phone call using the destination number information from the server process to the second handset. The method also connects the first VoIP phone call to the first mobile handset to the second VoIP phone call to the second handset through the server process. The method also includes exchanging voice information between the first mobile handset and the second handset free from an international toll charge.

### CROSS-REFERENCES TO RELATED APPLICATIONS

This application is a continuation of U.S. Utility application Ser. No. 11/248,071 titled Method and System for Processing International Calls Using a Voice Over IP Process, filed Oct. 11, 2005, which claims priority to U.S. Provisional Application No. 60/618,499, titled Mobile-to-Mobile Broadband Network System, filed Oct. 12, 2004; commonly assigned, and of which is hereby incorporated by reference for all purposes.

This present application also relates to U.S. application Ser. No. 11/248,683 titled Method and System for Call Routing for One or More Telephone Calls, filed on Oct. 11, 2005 and U.S. application Ser. No. 11/248,751 titled User Interface Method and System for Cellular Phone filed on Oct. 11, 2005; commonly assigned, and each of which is hereby incorporated by reference for all purposes.

### COPYRIGHT AND TRADEMARK NOTICE

A portion of this application contains computer codes, which are owned by Mino Holdings, Inc. All rights have been reserved under the copyright protection, Mino Holdings, Inc. ©2005. Additionally, the term “MINO” is a trademark of Mino Holdings, Inc. All rights have been reserved with respect to such trademark term.

### BACKGROUND OF THE INVENTION

The present invention relates to communication or telecommunication. More particularly, the present invention provides a technique, including a method and system, for initiating a phone call using a predetermined routing technique through a telecommunication network. As merely an example, the present invention is implemented on a cellular phone network. But it would be recognized that the present invention has a much broader range of applicability including local area networks, a combination of wide and local area networks, the Internet, and the like.

Telecommunication techniques have been around for numerous years. In the early days, people such as the American Indians communicated to each other over long distances using “smoke signals.” Smoke signals were generally used to transfer visual information from one geographical location to be observed at another geographical location. Since smoke signals could only be seen over a limited range of geographical distances, they were soon replaced by a communication technique known as telegraph. Telegraph generally transferred information from one geographical location to another geographical location using electrical signals in the form of “dots” and “dashes” over transmission lines. An example of commonly used electrical signals is Morse code. Telegraph has been, for the most part, replaced by telephone. The telephone was invented by Alexander Graham Bell in the 1800s to transmit and send voice information using electrical analog signals over a telephone line, or more commonly a single twisted pair copper line. Most industrialized countries today rely heavily upon telephone to facilitate communication between businesses and people, in general.

Other types of communication techniques have also been developed. An example of such communication technique is the so called cellular phone network. The cellular phone network relies upon a short-wave digital or analog telecommunication signals in which a subscriber has a wireless connection from a mobile telephone to a relatively nearby transmitter. The transmitter's span of coverage is often called a cell. Cellular telephone service is often available in urban areas and along major highways. As the cellular telephone user moves from one cell or area of coverage to another, the telephone is effectively passed on to the local cell transmitter. A newer service similar to cellular is personal communications services (PCS).

Although highly successful and useful, cellular phone services are often limited and expensive. For example, cellular phone services are often limited to selected geographic regions. Here, cellular phone services often have country or regional preferences. That is, certain phone services cannot call outside of geographic regions such as the United States of America. Additionally, cellular phone services are often expensive and difficult to change once the user locks into a particular service for a certain time frequency. Such time frequency often last for at least one year or so. These and other limitations of conventional cellular phone services are described throughout the present specification and more particularly below.

From the above, it is seen that a technique for improving the use of telecommunication networks is highly desirable

### BRIEF SUMMARY OF THE INVENTION

According to the present invention, techniques related to communication or telecommunication are provided. More particularly, the present invention provides a technique, including a method and system, for initiating a phone call using a predetermined routing technique through a telecommunication network. As merely an example, the present invention is implemented on a cellular phone network. But it would be recognized that the present invention has a much broader range of applicability including local area networks, a combination of wide and local area networks, the Internet, and the like.

In a specific embodiment, the present invention provides a method for processing a voice over IP (VoIP) call from a first mobile handset to a second handset. The method includes transferring destination number information associated with a destination number (for a callee) within a first country code from the first mobile handset to a data network, which is coupled to a world wide network of computers. The method includes transferring caller number information associated with a caller number within a second country code from the first mobile handset to the data network. In a preferred embodiment, the second country code is different from the second country code. The method includes receiving the destination information at a call server process, which is coupled to the world wide network of computers. The method includes receiving the caller number information at the call server process and initiating a first VoIP phone call using the caller number information from the server process to the first mobile handset. The method includes initiating a second VoIP phone call using the destination number information from the server process to the second handset. Here, the terms “first VoIP phone call” and term “second VoIP phone call” are not intended to imply any order in reference to time, but are merely provided for illustrative purposes according to a specific embodiment, although other embodiments may include a specific order. The method includes connecting the first VoIP phone call to the first mobile handset to the second VoIP phone call to the second handset through the server process. That is, the first VoIP call is connected to the second VoIP call using the server process at the server location in a specific embodiment. The method includes exchanging voice information between the first mobile handset and the second handset once the first and second handsets have been connected to each other.

In an alternative specific embodiment, the present invention provides a system for processing a voice over IP (VoIP) call from a first mobile handset to a second handset. In a preferred embodiment, the system has one or more computer readable memories, which include various computer codes. One or more codes are directed to receiving destination number information associated with a destination number within a first country code from a data network coupled to the first mobile handset. In a preferred embodiment, the data network is coupled to a world wide network of computers. The system also has one or more codes directed to receiving caller number information associated with a caller number within a second country code from the data network coupled to the first mobile handset. The second country code is different from the second country code. One or more codes are directed to processing the destination information at a call server process, which is coupled to the world wide network of computers. One or more codes are directed to processing the caller number information at the call server process. One or more codes are directed to initiating a first VoIP phone call using the caller number information from the server process to the first mobile handset. One or more codes are directed to initiating a second VoIP phone call using the destination number information from the server process to the second handset. One or codes are directed to connecting the first VoIP phone call to the first mobile handset to the second VoIP phone call to the second handset through the server process. Depending upon the embodiment, three may be other computer codes that carry out certain functionality described herein as well as outside of the present specification.

Still further, the present invention provides a method for processing an multi-country international phone call, free from an international toll charge, using a voice over IP (VoIP) call from a first mobile handset to a second handset. The method includes transferring destination number information associated with a destination number within a first country code from the first mobile handset to a data network, which is coupled to a world wide network of computers. In a preferred embodiment, the handset is coupled via cellular network through a data network to the world wide network of computers. The method includes transferring caller number information associated with a caller number within a second country code from the first mobile handset to the data network. In a preferred embodiment, the second country code is different from the second country code. The method includes receiving the destination information at a call server process, which is coupled to the world wide network of computers. The method also includes receiving the caller number information at the call server process. The method initiates a first VoIP phone call using the caller number information from the server process to the first mobile handset. The method initiates a second VoIP phone call using the destination number information from the server process to the second handset. The method also connects the first VoIP phone call to the first mobile handset to the second VoIP phone call to the second handset through the server process. The method also includes exchanging voice information between the first mobile handset and the second handset free from an international toll charge.

Many benefits are achieved by way of the present invention over conventional techniques. For example, the present technique provides an easy to use process that relies upon conventional technology. In some embodiments, the method provides for improved rates for phone calls with improved quality factors. Additionally, the method and system provide a process that is compatible with conventional telecommunication and computer hardware and software technology without substantial modifications to conventional equipment and processes. Preferably, the invention provides for an efficient way of making international long distance phone calls without the high costs of conventional techniques. Depending upon the embodiment, one or more of these benefits may be achieved. These and other benefits will be described in more throughout the present specification and more particularly below.

The objects, features, and advantages of the present invention, which to the best of our knowledge are novel, are set forth with particularity in the appended claims. The present invention, both as to its organization and manner of operation, together with further objects and advantages, may best be understood by reference to the following description, taken in connection with the accompanying drawings.

### BRIEF DESCRIPTION OF THE DRAWINGS

FIG. 1 is a simplified overview of a telephone routing system according to an embodiment of the present invention;

FIG. 1A is an alternative simplified overview of a telephone routing system according to an alternative embodiment of the present invention;

FIG. 2 is a simplified diagram of a least cost routing switch according to an embodiment of the present invention;

FIG. 3 is a simplified flow diagram of a least cost routing method according to an embodiment of the present invention;

FIGS. 4 and 5 are look up tables for least cost routing according to embodiments of the present invention;

FIG. 6 is a simplified diagram of multiple switches for a least cost routing method according to an embodiment of the present invention;

FIG. 7 is a simplified flow diagram of a least cost routing method according to an embodiment of the present invention;

FIGS. 8 and 9 are user interfaces for a handset according to embodiments of the present invention;

FIGS. 10 through 13 are tables associated with least cost routing according to embodiments of the present invention;

FIG. 14 is a simplified software component diagram according to an embodiment of the present invention;

FIG. 15 is a simplified diagram of a least cost routing switch system according to an embodiment of the present invention;

FIG. 16 is a simplified flow diagram of a user interface method according to an embodiment of the present invention;

FIGS. 17 through 20 are simplified flow diagrams of a call flow according to an embodiment of the present invention;

FIGS. 21 through 23 are simplified flow diagrams of a call back flow according to an embodiment of the present invention;

FIGS. 24 and 25 are simplified flow diagrams of methods for call back according to alternative embodiments of the present invention; and

FIG. 26 is a simplified flow diagram of a user interface according to an embodiment of the present invention;

FIG. 27 is a simplified flow diagram illustrating a method for sign in and update for a user interface according to an embodiment of the present invention;

FIG. 28 is a simplified flow diagram illustrating a call method for a user interface according to an embodiment of the present invention;

FIGS. 29 and 30 are simplified flow diagrams illustrating a phone book method for a user interface according to an embodiment of the present invention;

FIGS. 31 and 32 are simplified flow diagrams illustrating a call log method for a user interface according to an embodiment of the present invention;

FIG. 33 are simplified flow diagrams illustrating an account status method and setting method for a user interface according to an embodiment of the present invention; and

FIG. 34 is a simplified flow diagram illustrating a help method for a user interface according to an embodiment of the present invention

### DETAILED DESCRIPTION OF THE INVENTION

According to the present invention, techniques related to communication or telecommunication are provided. More particularly, the present invention provides a technique, including a method and system, for initiating a phone call using a predetermined routing technique through a telecommunication network. As merely an example, the present invention is implemented on a cellular phone network. But it would be recognized that the present invention has a much broader range of applicability including local area networks, a combination of wide and local area networks, the Internet, and the like.

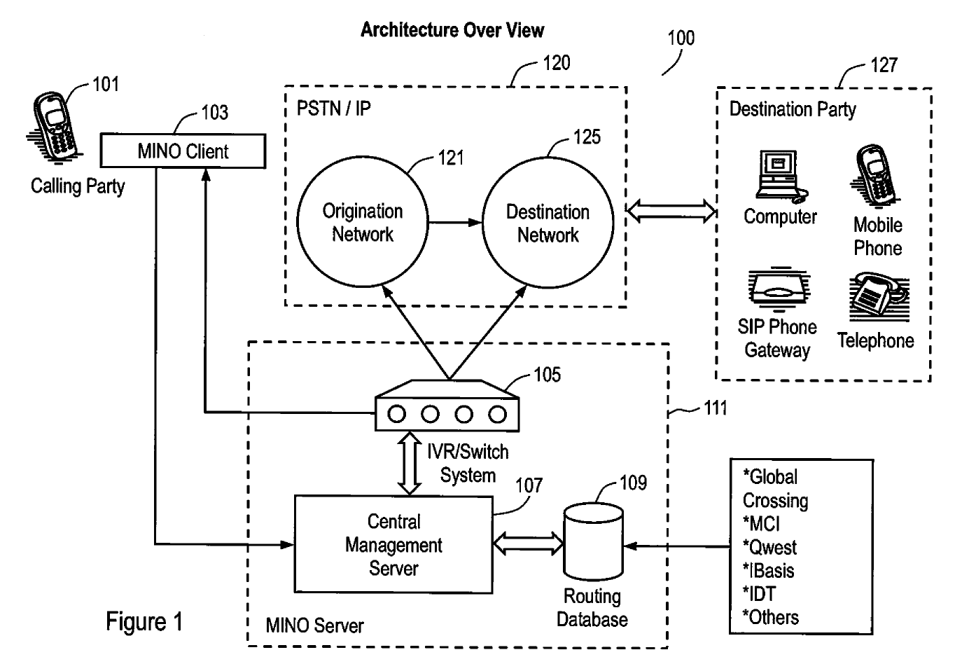

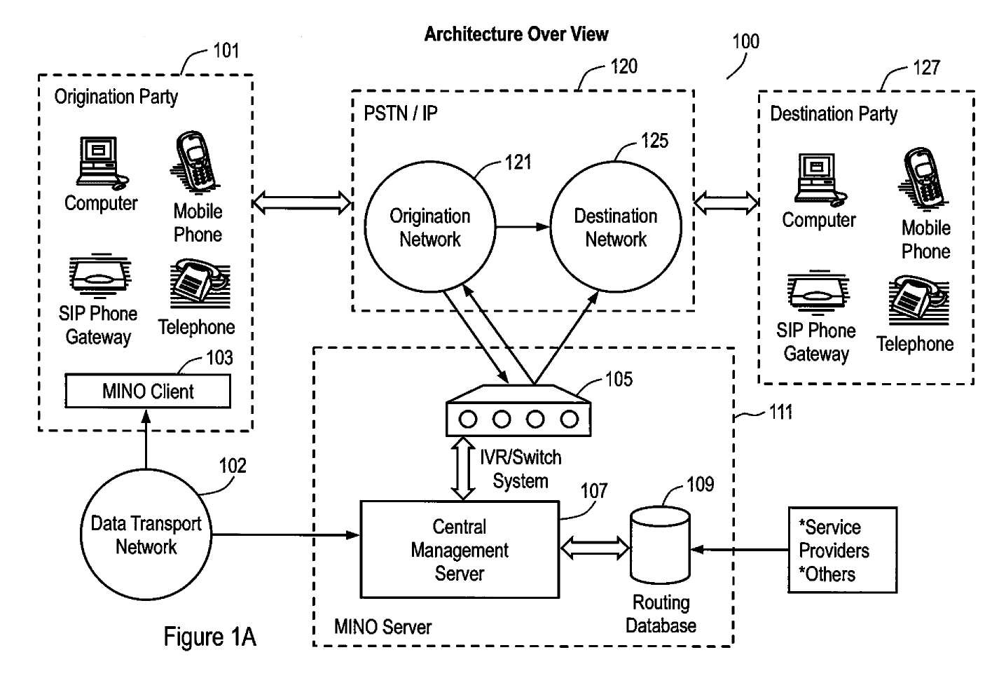

FIG. 1 is a simplified overview of a telephone routing system 100 according to an embodiment of the present invention. This diagram is merely an example, which should not unduly limit the scope of the claims herein. One of ordinary skill in the art would recognize many variations, modifications, and alternatives. As shown, the system includes a calling party 101, which is often a cell phone or other remote communication device. The calling party includes a client device, which couples to a switching system 105 and a management server 107. The management server, which includes a computer or multiple computers, is coupled to routing database 109. The switching system, management server, and routing database are provided in one or more server devices, which couple to communication network 120. The communication network includes at least an origination network 121 and a termination network 125 according to a specific embodiment. In a specific embodiment, the origination network is a cellular network such as GSM, GPRS (i.e., General Packet Radio Service), CDMA (i.e., Code Division Multiple Access), EDGE Enhanced Data for GSM Evolution, 3GSM, DECT, IS-136, and iDEN, analog, and any combination of these, and the like. Of course, there can be other variations, modifications, and alternatives. The termination network is coupled to a called party 127. In a specific embodiment, the termination network can be a wired network a cellular network, a paging network, any combination of these, and others. Further details of the present system and methods are provided throughout the present specification and more particularly below.

FIG. 1A is an alternative simplified overview of a telephone routing system according to an alternative embodiment of the present invention. This diagram is merely an example, which should not unduly limit the scope of the claims herein. One of ordinary skill in the art would recognize many variations, modifications, and alternatives. Like reference numerals are used in this figure as the previous figure, but are not intended to be limiting in any manner. As shown, the system includes a calling party 101, which is often a cell phone or other remote communication device. The calling party includes a client device, which couples to a switching system 105 and a management server 107. The management server, which includes a computer or multiple computers, is coupled to routing database 109. The switching system, management server, and routing database are provided in one or more server devices, which couple to communication network 120. The communication network includes at least an origination network 121 and a termination network 125 according to a specific embodiment. In a specific embodiment, the origination network is a cellular network such as GSM, GPRS (i.e., General Packet Radio Service), CDMA (i.e., Code Division Multiple Access), EDGE Enhanced Data for GSM Evolution, 3GSM, DECT, IS-136, and iDEN, analog, and any combination of these, and the like. Of course, there can be other variations, modifications, and alternatives. The termination network is coupled to a called party 127. In a specific embodiment, the termination network can be a wired network a cellular network, a paging network, any combination of these, and others.

In a specific embodiment certain operations may be performed. That is, client 105 device sends call information, which may include destination number, origination number and user authentication information, through data network to a central management server 107. An IVR/switch system 105 connects the origination party and destination party according to a specific embodiment. Of course, there can be other variations, modifications, and alternatives.

In a specific embodiment, the client device or originating party may be a mobile handset, PDA, computer, VOIP gateway, soft switch or any other devices that have access to a data network 102. Depending upon the specific embodiment, the originating device may or may not have a call feature according to the present invention. As shown, an origination number and destination number can be a telephone number in the PSTN network, and/or unique identification (e.g., id) in the voice over Internet Protocol (i.e., VOIP) network and/or any combination and the like. After the server receives call information, it initiates the call and connects the origination party and destination party through origination network 121 and termination network 125 according to a specific embodiment. The origination party and destination party are the devices that can make calls and/or receive calls, such as fixed line phone, mobile phone, VOIP phone, computers running calling software, and any combination and the like 127. The origination party can initiate the call and connect destination party through IR/Switch System 105 as well. Also IVR/Switch System can initiate calls to both origination party destination party, then connect them together according to a specific embodiment. Further details of the present system and methods are provided throughout the present specification and more particularly below.

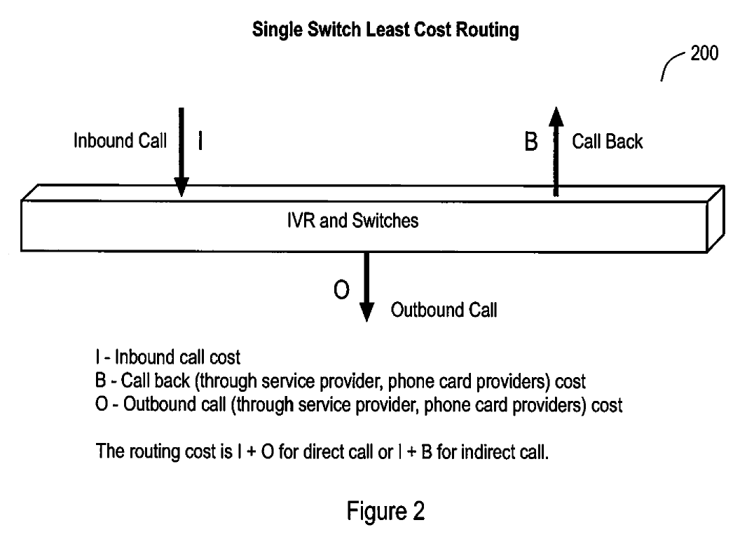

FIG. 2 is a simplified diagram of a least cost routing switch 200 according to an embodiment of the present invention. This diagram is merely an example, which should not unduly limit the scope of the claims herein. One of ordinary skill in the art would recognize many variations, modifications, and alternatives. As shown, the least cost routing switch includes an inbound call “I”, an outbound call “O”, and call back “B” that relate respectively to costs associated with the inbound call, call back cost, and outbound call cost. Further details of a method for least cost routing according to an embodiment of the present invention can be found throughout the present specification and more particularly below.

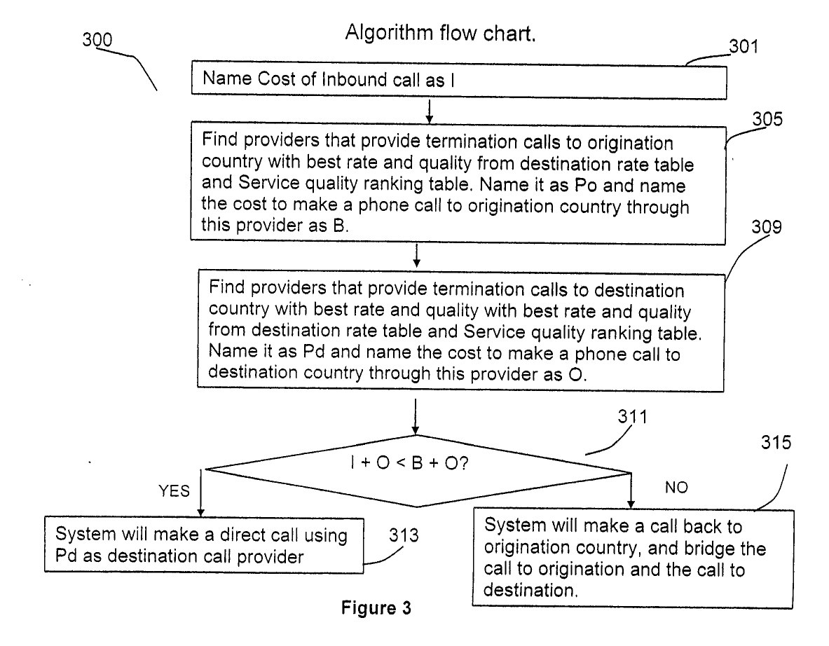

A method for least cost routing from a caller can be briefly outlined as follows, which can also be referenced to FIG. 3:

1. Identify cost of inbound call (step 301);

2. Find providers (step 305) using rate table from origination country;

3. Find providers (step 309) using rate table to destination country;

4. Determine (step 311) if I+O<B+O;

5. Initiate direct call (step 313) using Pd as destination call provider, if “YES”;

6. Initiate call back (step 315) to origination country, if “NO”;

7. Perform other steps, as desired.

The above sequence of steps provides method according to an embodiment of the present invention. As shown, the method uses a combination of steps including a way of determining a communication route with desirable properties, such as cost, quality, and other factors, depending upon the embodiment. Of course, other alternatives can also be provided where steps are added, one or more steps are removed, or one or more steps are provided in a different sequence without departing from the scope of the claims herein. Additionally, the various steps can be implemented using a computer code or codes in software, firmware, hardware, or any combination of these. Depending upon the embodiment, there can be other variations, modifications, and alternatives.

As noted, FIG. 3 is a simplified flow diagram 300 of a least cost routing method according to an embodiment of the present invention. This diagram is merely an example, which should not unduly limit the scope of the claims herein. One of ordinary skill in the art would recognize many variations, modifications, and alternatives. As shown, the method determines whether to use a destination call provider (step 313), which is known already, or call back to origination method (step 315) according to a specific embodiment. A determination of selecting the call provider uses certain rate and quality ranking tables, which will be described in more detail below.

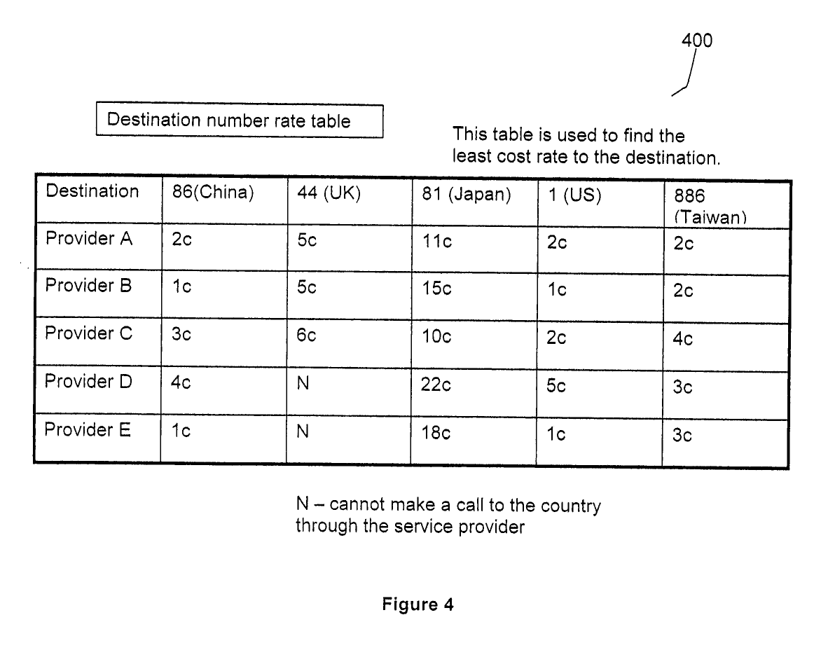

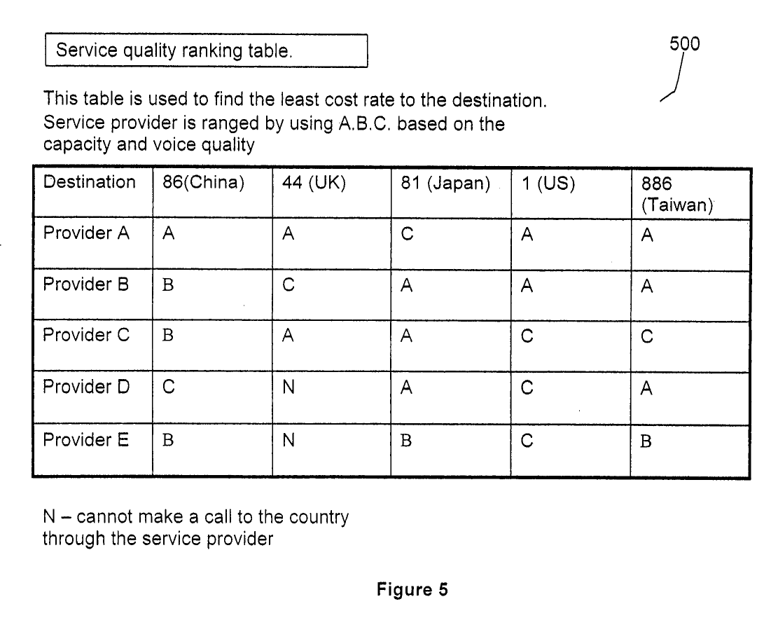

FIGS. 4 and 5 are look up tables 400, 500 for least cost routing according to embodiments of the present invention. These diagrams are merely examples, which should not unduly limit the scope of the claims herein. One of ordinary skill in the art would recognize many variations, modifications, and alternatives. As shown, look up table 400 provides a listing of destination providers A, B, C, D, E, according to a specific embodiment. Depending upon the embodiment, there may be fewer providers or more providers. The table lists the various destination locations, including China, UK, Japan, U.S. and Taiwan. Again, there can be fewer destinations or more destinations according to specific embodiments. Each of the providers lists a rate, which has been provided as a rate-per unit time, i.e., minute. Certain providers have rates listed as “N” that indicates that the listed provider (such as Provider D) cannot make a call to the UK, for example. Of course, there can be other variations, modifications, and alternatives.

As also shown, look up table 500 provides a listing of destination providers A, B, C, D, E, according to a specific embodiment. Depending upon the embodiment, there may be fewer providers or more providers. The table lists the various destination locations, including China, UK, Japan, U.S., and Taiwan. Again, there can be fewer destinations or more destinations according to specific embodiments. Each of the providers lists a quality rank, which has been provided as a grade, e.g., A, B, C. Here, A is the highest quality and C is the lowest quality according to a specific embodiment. Certain providers have grades listed as “N” that indicates that the listed provider (such as Provider D) cannot make a call to the UK, for example. Of course, there can be other variations, modifications, and alternatives. Further details of the present least cost routing method, including known service provider or call back method, can be found throughout the present specification and more particularly below.

In a specific embodiment, a method for least cost routing using a known service provider is outlines as follows.

1. Provide a predetermined telephone number to be called from a handset from a geographic location;

2. Identify more than one service provider from a plurality of service providers in a database having an access number associated geographic location to provide a first set of service providers;

3. Identify a destination location associated with the predetermined telephone number;

4. Determine more than one of the identified service providers having termination capability for the destination location associated with the predetermined telephone number to form a second set of service providers;

5. Determine at least one of the service providers in the second set of service providers having a selected cost information and a selected quality information associated with the predetermined telephone number from the geographic location;

6. Select the service provider from step (5);

7. Initiate a call based upon the predetermined telephone number using the selected service provider; and

8. Connect the handset to a receiving device associated with the predetermined telephone number; and

9. Perform other steps, as desired.

The above sequence of steps provides method according to an embodiment of the present invention. As shown, the method uses a combination of steps including a way of determining a communication route with desirable properties, such as cost, quality, and other factors, using known service providers depending upon the embodiment. Of course, other alternatives can also be provided where steps are added, one or more steps are removed, or one or more steps are provided in a different sequence without departing from the scope of the claims herein. Additionally, the various steps can be implemented using a computer code or codes in software, firmware, hardware, or any combination of these. Depending upon the embodiment, there can be other variations, modifications, and alternatives.

In yet an alternative specific embodiment, the present invention provides a method for using a call back technique for least cost routing, which may be outlined as follows. Here, the method includes determining a least cost routing method using an indirect call feature for a predetermined telephone call.

1. Provide a predetermined telephone number to be called from a handset from a geographic location to initiate a call through a telephone network;

2. Transfer the predetermined telephone number from the handset to a server device coupled to the telephone network;

3. Identify a first route using a first service provider for connecting the handset from the geographic location to a second geographic location;

4. Identify a second route using a second service provider for connecting the handset from the second geographic location to the predetermined telephone number;

5. Initiates a call based upon the predetermined telephone number using the second service provider and the second route;

6. Connects the handset using the first route to the second route using a call back process from the first service provider to the handset; and

7. Perform other steps as desired.

The above sequence of steps provides method according to an embodiment of the present invention. As shown, the method uses a combination of steps including a way of determining a communication route with desirable properties, such as cost, quality, and other factors, using call back depending upon the embodiment. Of course, other alternatives can also be provided where steps are added, one or more steps are removed, or one or more steps are provided in a different sequence without departing from the scope of the claims herein. Additionally, the various steps can be implemented using a computer code or codes in software, firmware, hardware, or any combination of these. Depending upon the embodiment, there can be other variations, modifications, and alternatives.

In yet an alternative embodiment, the present invention provides a method for operating a mobile handset through more than one calling route, which will be outlined briefly below.

1. Provide a mobile hand set comprising a user interface, an origination phone number, and a mobile application, which is coupled to a telephone network;

2. Enter a predetermined phone number through the user interface;

3. Determine a destination location of the predetermined phone number, which is associated with a receiver device;

4. Determine a calling location of the mobile handset and identifying total cost information numbered from 1 through N associated with the predetermined phone number for a plurality of routes (that may include one or more sub routes) numbered respectively from 1 through N, where N is an integer greater than 1;

5. Outputs a least total cost information associated with the predetermined phone number to a user of the mobile handset for at least one of the routes numbered from 1 through N;

6. Initiate a connection between the mobile handset and the receiver device at the destination location; and

7. Perform other steps, as desired.

The above sequence of steps provides method according to an embodiment of the present invention. As shown, the method uses a combination of steps including a way of determining a communication route with desirable properties, such as cost, quality, and other factors, using multiple routes depending upon the embodiment. Of course, other alternatives can also be provided where steps are added, one or more steps are removed, or one or more steps are provided in a different sequence without departing from the scope of the claims herein. Additionally, the various steps can be implemented using a computer code or codes in software, firmware, hardware, or any combination of these. Depending upon the embodiment, there can be other variations, modifications, and alternatives.

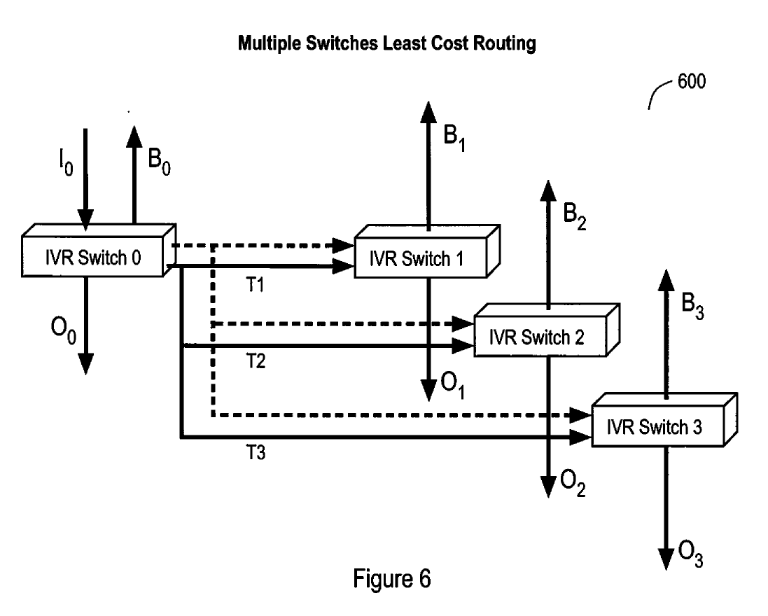

FIG. 6 is a simplified diagram of multiple switches 600 for a least cost routing method according to an embodiment of the present invention. This diagram is merely an example, which should not unduly limit the scope of the claims herein. One of ordinary skill in the art would recognize many variations, modifications, and alternatives. As shown, the multiple switches are located geographically at different countries. As merely an example, the switches include IVR (“Interactive Voice Response”)/Switch0, IVR/Switch1, IVR/Switch2, IVR/Switch3 located at four different country, e.g., U.S. U.K., China, Japan, Taiwan. As shown, IVR Switch0 takes an origination call Io.

As an example, the multiple switches generates a call back from one of the IVR switches from IVR Switch0 to IVR Switch3. As also shown, one of the routes from B0 to B3 is selected. A termination call can be generated from one of the IVR switches from IVR Switch0 to IVR Switch3. One of the outbound calls to destination from O0 to O3 is also selected. The original call will be transferred from the origination country where IVRswitche0 is located to one of the IVR/Switches in an other country. The cost transfer between switches will be T. As an example, the cost transfer can be T1, T2, or T3. As also shown, dash links between switches indicates data transfer between switches through the Internet that is essentially free of costs. In a specific embodiment, such Internet calls rely upon voice over IP processes. Each IVR/Switch has a destination number rate table and a service quality ranking table associated with it. In a specific embodiment, the rate table and quality ranking table can be similar to those noted above, but can also be variations of such tables depending upon the specific embodiment.

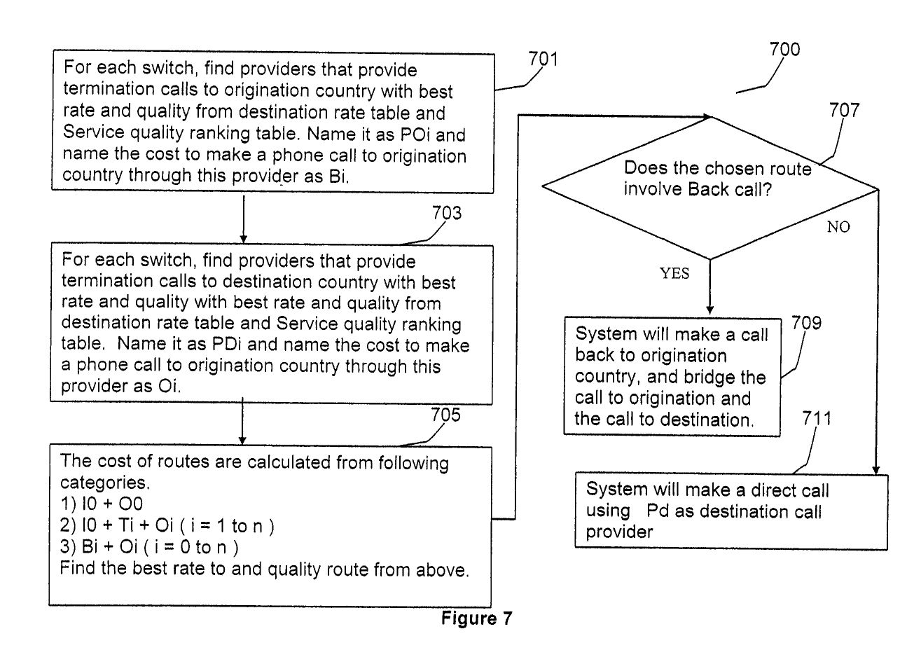

FIG. 7 is a simplified flow diagram of a least cost routing method 700 using multiple switches according to an embodiment of the present invention. This diagram is merely an example, which should not unduly limit the scope of the claims herein. One of ordinary skill in the art would recognize many variations, modifications, and alternatives. As shown, the method begins by determining (step 701) service providers that provide termination calls to a origination country considering a best calling rate and quality from the destination rate table and the service quality ranking table according to a specific embodiment. The determining step (step 701) is provided for each of the switches according to a specific embodiment. The method then determines (step 703) services providers that provide termination calls to a destination country considering a best calling rate and quality from the destination rate table and the service quality ranking table according to a specific embodiment. The determining step (step 703) is provided for each of the switches according to a specific embodiment.

Next, the method calculates costs of routes according to step 705 in a specific embodiment of the present invention. A sample calculation has been provided below according to a specific embodiment. Preferably, the method uses certain values in a predetermined table that lists various costs associated with various service providers for the cost of the routes. The costs are often ranked according to a magnitude of a calling rate, often measured in a financial value per unit time, such as cents per minute. Of course, one or ordinary skill in the art would recognize other variations, modifications, and alternatives.

The method determines if the selected route involves a call back process, step 707. If “YES,” the method performs a call back process to the origination country. The method bridges (step 711) the call between the origination and the destination according to a specific embodiment. Alternatively if “NO,” the method performs (step 709) a direct call using a destination call provider according to a specific embodiment of the present invention. Of course, there can be other variations, modifications, and alternatives.

The above sequence of steps provides method according to an embodiment of the present invention. As shown, the method uses a combination of steps including a way of determining a communication route with desirable properties, such as cost, quality, and other factors, using multiple switches depending upon the embodiment. Of course, other alternatives can also be provided where steps are added, one or more steps are removed, or one or more steps are provided in a different sequence without departing from the scope of the claims herein. Additionally, the various steps can be implemented using a computer code or codes in software, firmware, hardware, or any combination of these. Depending upon the embodiment, there can be other variations, modifications, and alternatives.

In a specific embodiment, the present invention provides a method for operating a mobile handset, e.g., cell phone, which may be outlined below.

1. Provide a mobile hand set comprising a user interface, an origination phone number, and a mobile application, which is coupled to a telephone network;

2. Enter a predetermined phone number through the user interface;

3. Determine a destination location (e.g., country, region), which is associated with a receiver device, of the predetermined phone number;

4. Determine a calling location of the mobile handset and identifying a cost information associated with the predetermined phone number;

5. Output the cost information associated with the predetermined phone number to a user of the mobile handset;

6. Initiate a connection between the mobile handset and the receiver device at the destination location;

7. Connect the mobile handset and the receiver device;

8. Exchange voice information between the mobile handset and the receiver device;

9. Terminate call; and

10. Perform other steps, as desired.

The above sequence of steps provides method according to an embodiment of the present invention. As shown, the method uses a combination of steps including a way of initiating a call and prompting cost information with a user interface on a handset according to a specific embodiment of the present invention. Of course, other alternatives can also be provided where steps are added, one or more steps are removed, or one or more steps are provided in a different sequence without departing from the scope of the claims herein. Additionally, the various steps can be implemented using a computer code or codes in software, firmware, hardware, or any combination of these. Depending upon the embodiment, there can be other variations, modifications, and alternatives.

In an alternative specific embodiment, the present invention provides an alternative method for operating a mobile handset, which is briefly outlined below.

1. Provide a mobile hand set comprising a user interface and a mobile application, which is coupled to a telephone network;

2. Enter a predetermined phone number through the user interface and determining a destination location of the predetermined phone number;

3. Determine a calling location of the mobile handset;

4. Identify a balance information for a customer associated with the mobile handset;

5. Outputting the balance information associated with the customer to a user of the mobile handset; and

6. Perform other steps as desired.

The above sequence of steps provides method according to an embodiment of the present invention. As shown, the method uses a combination of steps including a way of initiating a call and prompting cost information with a user interface on a handset according to a specific embodiment of the present invention. Of course, other alternatives can also be provided where steps are added, one or more steps are removed, or one or more steps are provided in a different sequence without departing from the scope of the claims herein. Additionally, the various steps can be implemented using a computer code or codes in software, firmware, hardware, or any combination of these. Depending upon the embodiment, there can be other variations, modifications, and alternatives. Further details of the present methods can be found throughout the present specification and more particularly below.

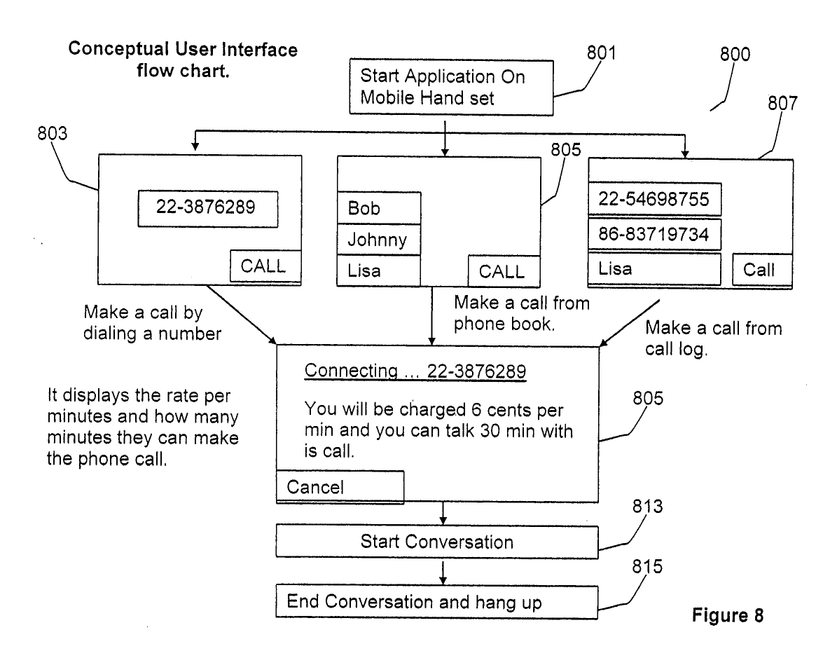

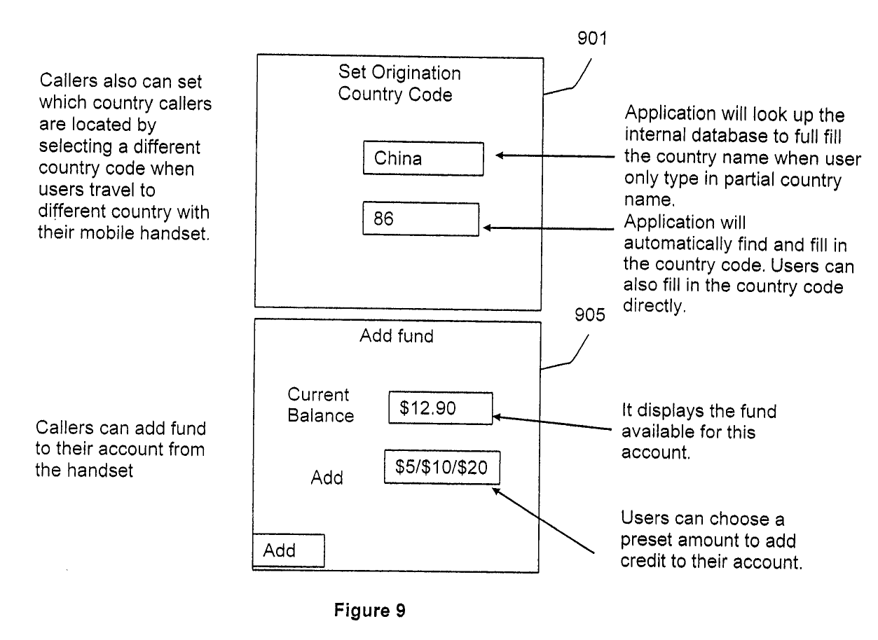

FIGS. 8 and 9 are user interfaces for a handset according to embodiments of the present invention. These diagrams are merely examples, which should not unduly limit the scope of the claims herein. One of ordinary skill in the art would recognize many variations, modifications, and alternatives. As shown, the present invention provides a method for operating a mobile handset, e.g., cell phone, which begins at start, step 801. The method includes providing a mobile hand set comprising a user interface, an origination phone number, and a mobile application, which is coupled to a telephone network. The method includes entering a predetermined phone number through the user interface. The phone number can be entered using a variety of techniques such as dialing 803 or key entry, retrieving a phone number from a phone book 805, which has been stored in memory, or entering a phone number from a call long 807, any combination of these techniques, and the like. Of course, one of ordinary skill in the art would recognize many variations, alternatives, and modifications.

Next, the method includes determining a destination location (e.g., country, region) of the predetermined phone number. The destination location is associated with a receiver device. The method includes determining a calling location of the mobile handset and identifying a cost information associated with the predetermined phone number. In a specific embodiment, the cost information has been retrieved using any one of the methods and systems described herein, as well as outside of the present specification depending upon the specific embodiment.

The method also includes outputting (step 811) the cost information associated with the predetermined phone number to a user of the mobile handset. As shown, the method outputs a calling rate (e.g., 6 cents per minute) and a total time left, i.e., 30 minutes. Concurrent with the outputting, the method may also include initiating a connection between the mobile handset and the receiver device at the destination location according to a specific embodiment. The method includes making a connection between the mobile handset and receiver device and exchanging voice information, step 813, according to a specific embodiment. Once the call has been terminated, the method initiates a hang up (step 815) process according to a specific embodiment. Of course, there can be other variations, modifications, and alternatives.

In an alternative specific embodiment, the present invention provides an alternative method for operating a mobile handset. The method includes providing a mobile hand set comprising a user interface and a mobile application, which is coupled to a telephone network. The method includes entering a predetermined phone number through the user interface and determining a destination location of the predetermined phone number.

In a specific embodiment, the method includes providing a country code that the caller is located using the present user interface 901 according to a specific embodiment. In a specific embodiment, the user may input the country code, which will retrieve a country from one or more memories of a table and/or database coupled to the user interface. As an example, the user entered “86” which is the country code for “China” as shown. The country “China” is retrieved and outputted on the user interface, as shown. Alternatively, the user enters the country, such as “China” and the present method will automatically look up the country code, which is provided in a field of the user interface. Of course, there can be other variations, modifications, and alternatives.

The method includes determining a calling location of the mobile handset and identifying a balance information 905 for a customer associated with the mobile handset. The method includes outputting the balance information associated with the customer to a user of the mobile handset. Depending upon the embodiment, the user may also add additional finds to credit the user's phone application using the user interface according to a specific embodiment. The method adds discrete amounts such as $5/$10/$10 U.S. dollars according to a specific embodiment. Alternatively, the method can allow for any other quantities, which are taken from a credit card or payment plan according to a specific embodiment. Of course, there can be other variations, modifications, and alternatives. Further details of the present method can be found throughout the present specification and more particularly below.

In yet an alternative specific embodiment, the present invention provides a mobile handset. In a specific embodiment, the mobile hand set enclosure has a user interface and a mobile application, which is coupled to a telephone network. The mobile handset enclosure comprises one or more memories, which have certain computer codes. Such codes may be in software, firm ware, or other forms of memory, or any combination of these, depending upon the specific embodiment. One or more codes is directed to receive a predetermined phone number through the user interface. One or more codes is directed to determine a destination location of the predetermined phone number. One or more codes is directed to determine a calling location of the mobile handset. One or more codes is directed to identifying a balance information for a customer associated with the mobile handset. One or more codes is directed to outputting the balance information associated with the customer to a user of the mobile handset. Depending upon the specific embodiment, there may also be other codes or certain codes may be removed as well.

### EXAMPLES

To prove the principle and operation of the present invention, we performed certain experiments using computer software, mobile handsets, and conventional hardware. These experiments are merely examples, which should not unduly limit the scope of the claims herein. One of ordinary skill in the art would recognize many variations, modifications, and alternatives.

According to a specific embodiment, we have provided a least cost routing method as follows.

An in-bound call cost is calculated on a contract negotiated with one or more service providers that generate origination calls. It depends on the contracts, usually service providers charge a flat monthly fee or rate per minutes based on volume. An estimated monthly usage in minutes is used to calculate the cost per minute. In-bound call cost per minute I=monthly fee/estimated monthly usage. In this example, the in bound call cost per minute “I” will be used in the present methods and systems for determining a least cost routing according to a specific embodiment.

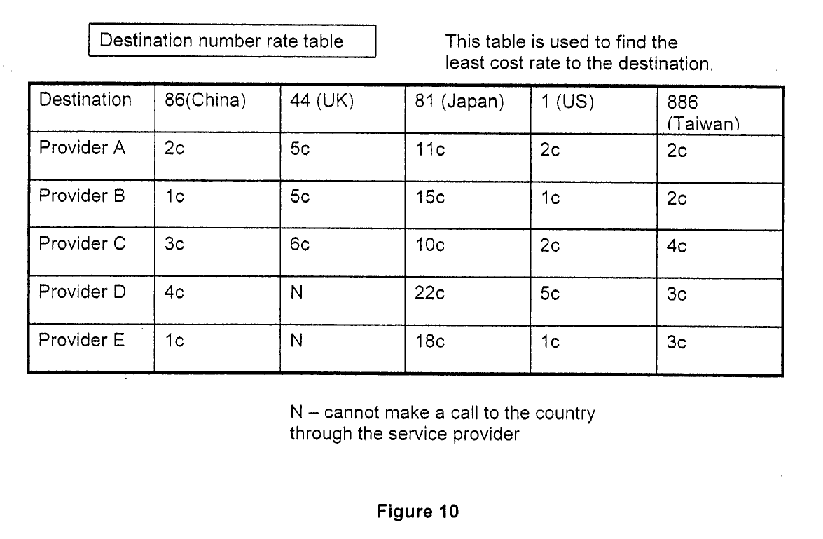

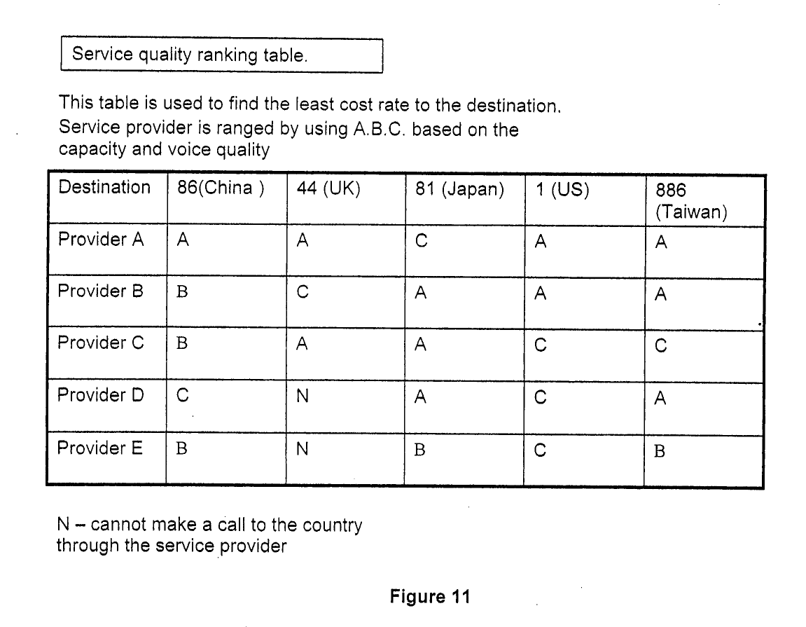

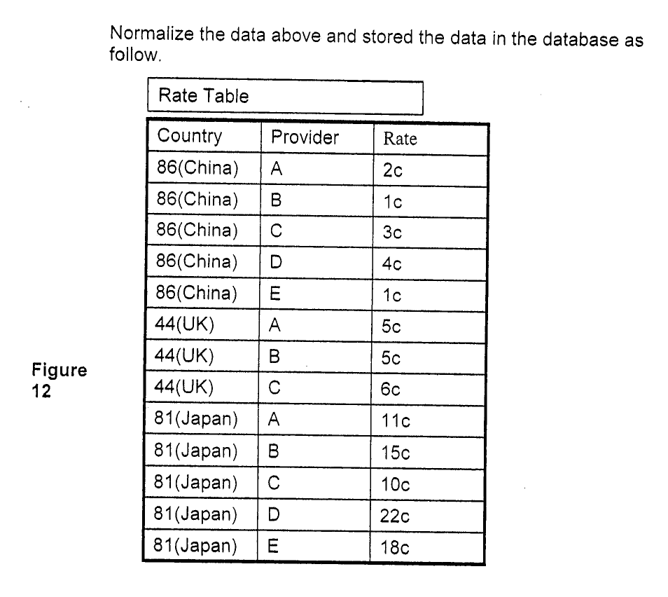

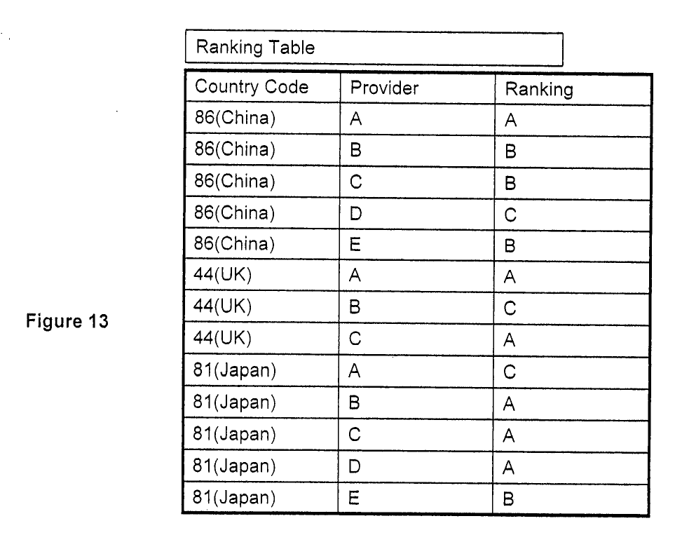

A database is established to store Termination Rate Table and Service Quality Ranking Table. As merely an example, the Table are illustrated using FIGS. 10 and 11. As shown, data in the Termination Rate Table is collected from service providers and updated regularly in the database. Data in the service quality table is collected from user survey. A survey is sent out to all users or certain users according to a specific embodiment. The rating for each country is input to Service Quality Ranking Table based on the feed back from users. The system receives the origination number and destination number send from user remotely from mobile device, and system uses this information to determine least cost routes.

Out Bound call cost “O” is determined as follow.

1. Run a query against Rate Table and select providers where termination country is available in the Termination Rate Table;

2. Order the results by the rate and put the provider with lowest rate on the top.

In a specific embodiment, the pseudo SQL statement may look like the following:

Select Provider, Rate from Rate_Table where country_Code=[termination country code] order by Rate ascending.
Name the result set as Provider_Rate_Table.

In a specific embodiment, the method runs a query against Service Quality Table. Among the providers with low rate selected from above, select the provider with the highest rating. As shown, the pseudo SQL statement may look like the following:

Select Provider, Ranking from Provider_Rate_Table, Ranking_Table where
Provider_Rate_Table.Provider=Ranking_Table.Provider order by Ranking descending

The method selects the top provider from result set for termination calls. By using this provider to terminate the call, the cost is O. The method calls back cost B determined as follow. The process is very similar to the find the Out Bound Cost, O. The only difference is origination country code is used to search against the Rate Table. Detailed process is described as follow. The method runs a query against Rate Table and select providers where termination country is available in the Termination Rate Table. Order the results by the rate and put the provider with lowest rate on the top. The pseudo SQL statement may look like the following.

Select Provider, Rate from Rate_Table where country_Code=[origination country code] order by Rate ascending.
Name the result set as Provider_Rate_Table.

The method run a query against Service Quality Table. Among the providers with low rate selected from above, select the provider with the highest rating. The pseudo SQL statement may look like the following.

Select Provider, Ranking from Provider_Rate_Table, Ranking_Table where
Provider_Rate_Table.Provider=Ranking_Table.Provider order by Ranking descending
The method selects the top provider from result set for termination calls. By using this provider to call back, the cost is B. Depending upon the embodiment, there are two cases to determine the lowest cost routes. In a specific embodiment, there is no access number available in origination country, the call back and out bound call are used to establish as lowest cost route. The cost is B+O. Alternatively, the access number is available in the origination country. The present method and system compares cost of In-bound call plus Outbound call and Call back plus Outbound call. If Inbound call cost is cheaper than Outbound call cost, then Inbound call plus Outbound call route is used and the cost is I+O. Otherwise, Call back plus Outbound call is used and the cost is B+O. Of course, there may be other variations, alternatives, and modifications.

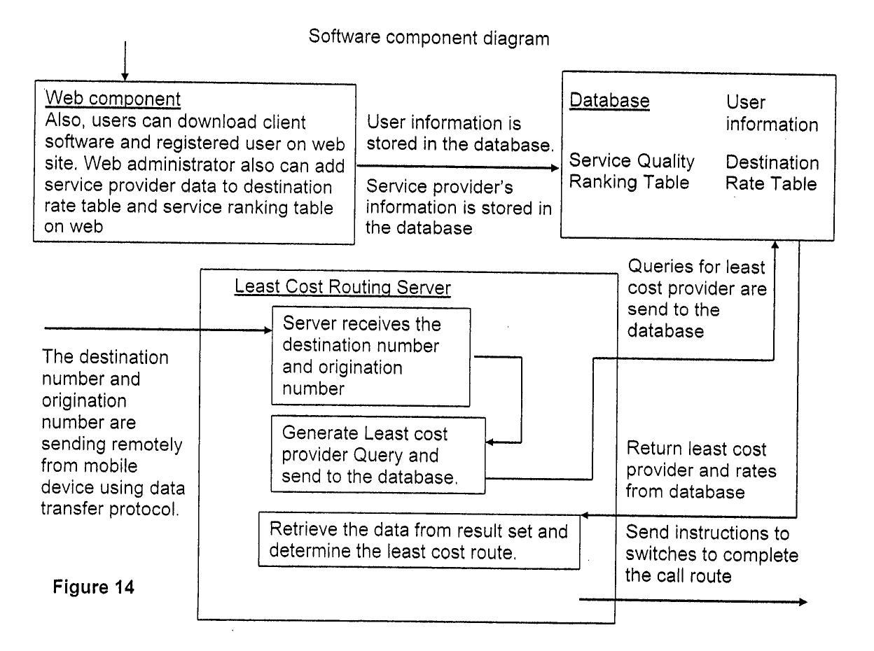

FIG. 14 is a simplified software component diagram according to an embodiment of the present invention. This diagram is merely an example, which should not unduly limit the scope of the claims herein. One of ordinary skill in the art would recognize many variations, modifications, and alternatives.

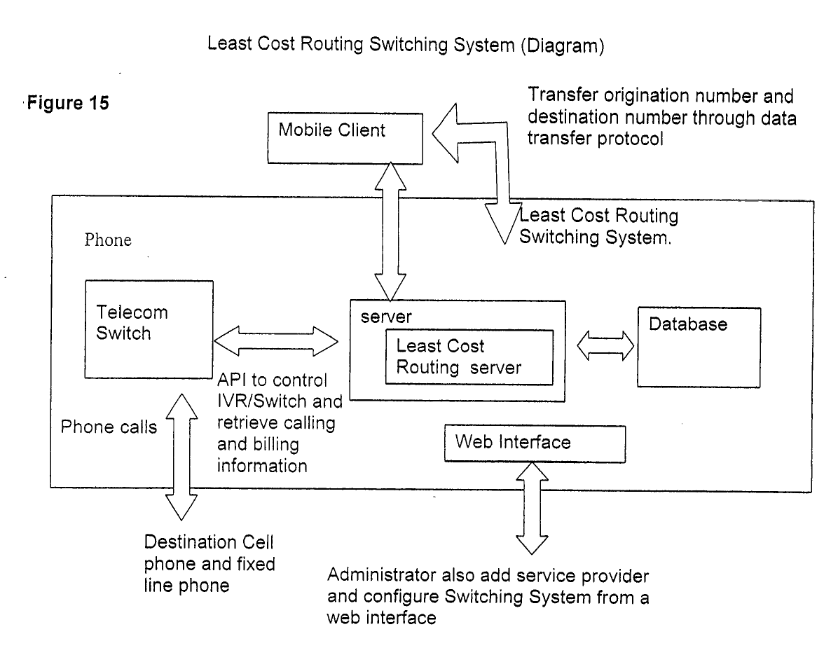

FIG. 15 is a simplified diagram of a least cost routing switch system according to an embodiment of the present invention. This diagram is merely an example, which should not unduly limit the scope of the claims herein. One of ordinary skill in the art would recognize many variations, modifications, and alternatives. As shown, the present routing switch has a routing server and a telecom switching device, and other elements. In a specific embodiment, the server is a server application that runs on a computer connected to the Internet and other networks. The system also has a database connected to the server to provide persistent storage according to a specific embodiment.

In a specific embodiment, the present system has a telecom switching device. Such switching device may provide functions such as receiving calls, initiating calls, bridging calls, terminating calls, and monitoring functions, and the like. The switching devices will connect to a service provider, who provides the origination call and termination call access to the public telephone network. Of course, there can be other variations, modifications, and alternatives.

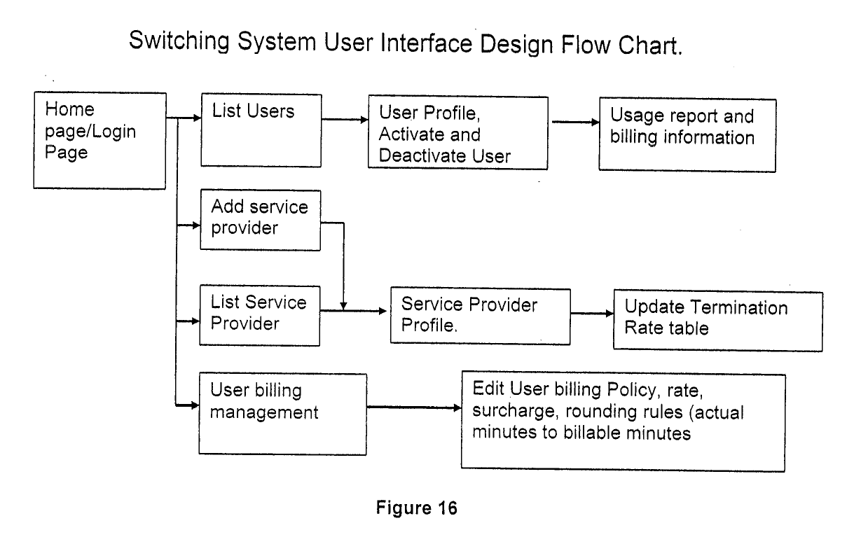

FIG. 16 is a simplified flow diagram of a user interface method according to an embodiment of the present invention. This diagram is merely an example, which should not unduly limit the scope of the claims herein. One of ordinary skill in the art would recognize many variations, modifications, and alternatives.

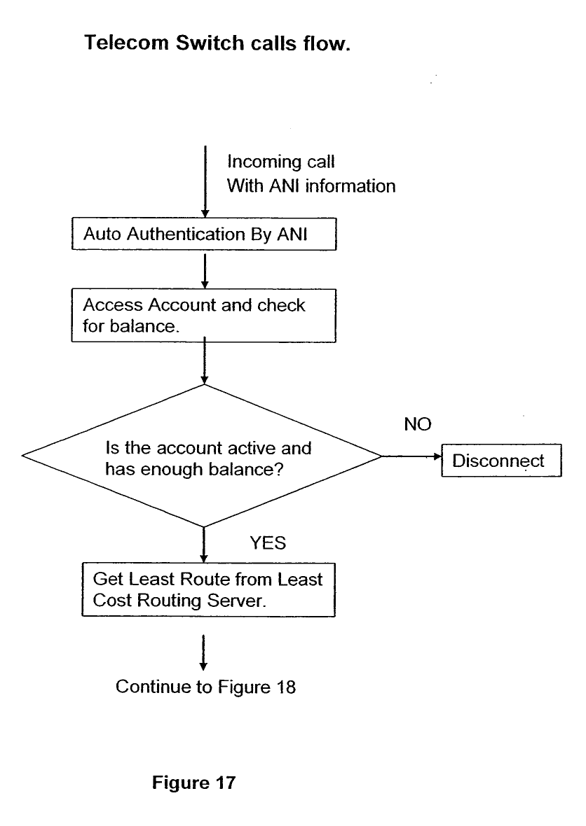

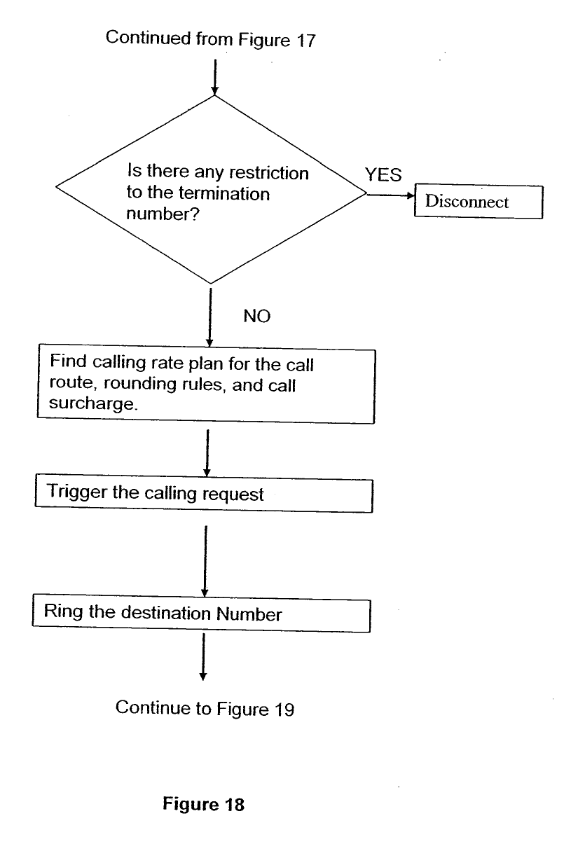

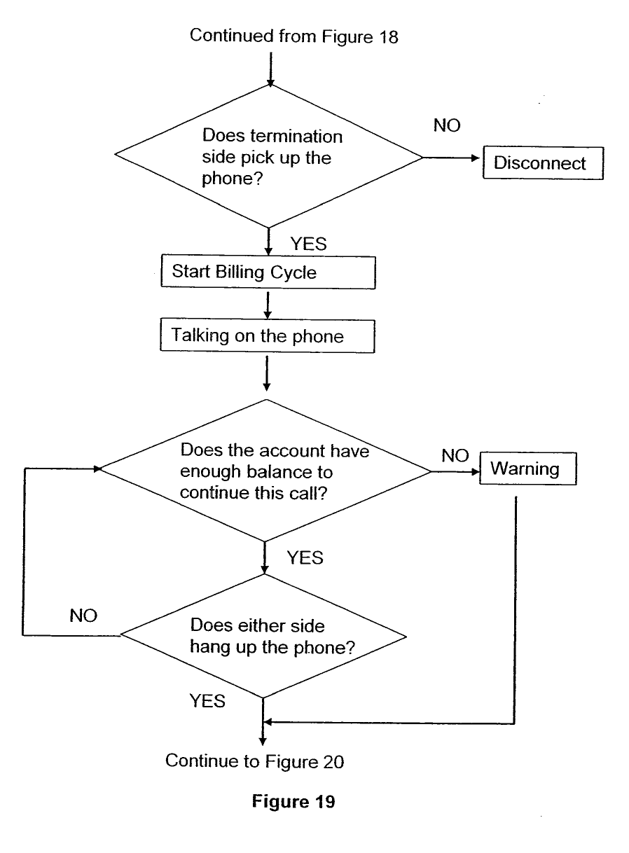

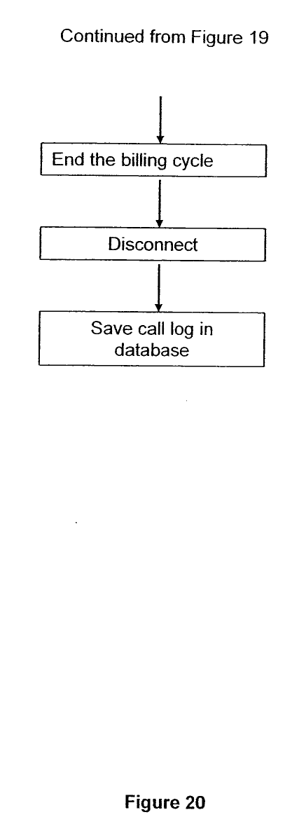

FIGS. 17 through 20 are simplified flow diagrams of a call flow according to an embodiment of the present invention. These diagrams are merely examples, which should not unduly limit the scope of the claims herein. One of ordinary skill in the art would recognize many variations, modifications, and alternatives.

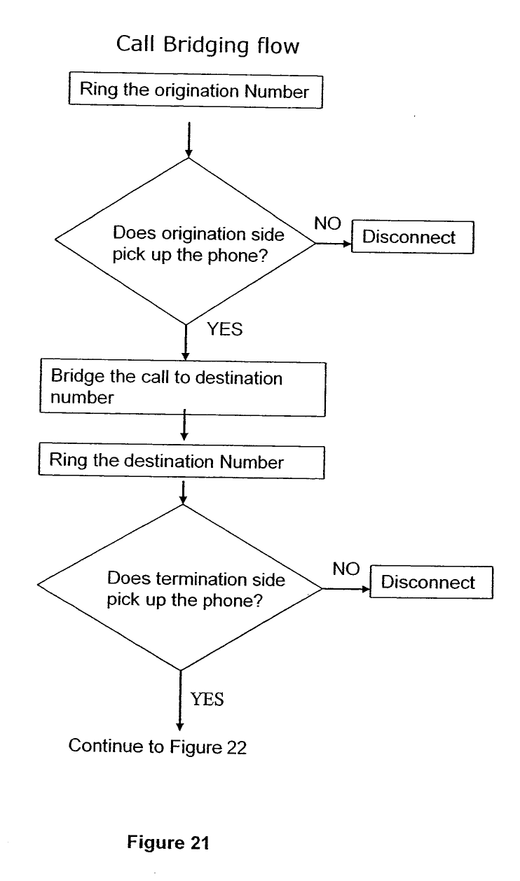

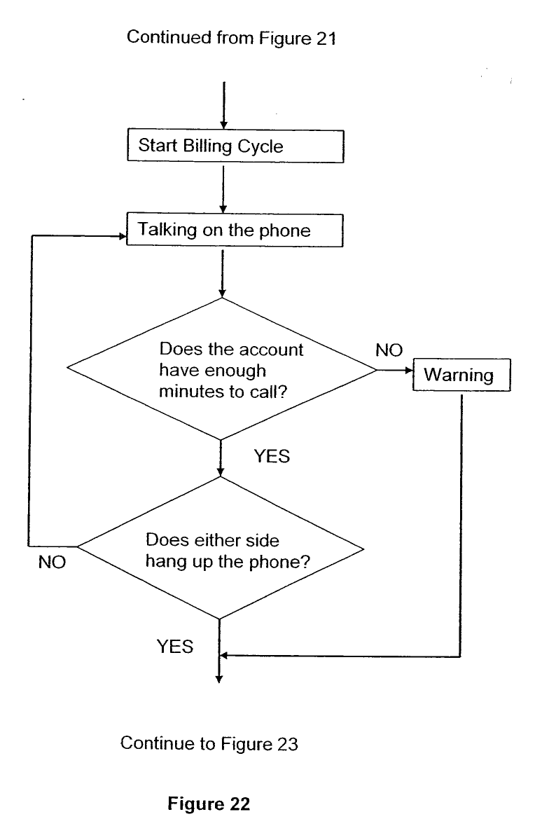

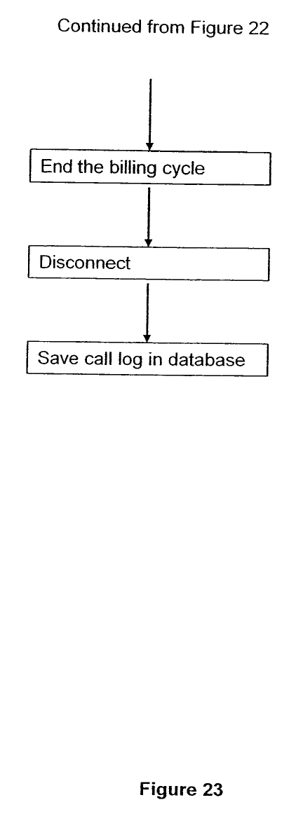

FIGS. 21 through 23 are simplified flow diagrams of a call back flow according to an embodiment of the present invention. These diagrams are merely examples, which should not unduly limit the scope of the claims herein. One of ordinary skill in the art would recognize many variations, modifications, and alternatives.

As used herein, the term ‘computer’ may include any processor-based or microprocessor-based system including systems using microcontrollers, digital signal processors (DSP), reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term ‘computer’. The computer system executes a set of instructions that are stored in one or more storage elements, in order to process input data. The storage elements may also hold data or other information as desired or needed. The storage element may be in the form of an information source or a physical memory element within the processing machine.

The set of instructions may include various commands that instruct the processing machine to perform specific operations such as the processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms ‘software’ and ‘firmware’ are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

In a specific embodiment, a method for using call forward according to a specific embodiment is outlines as follows.

1. Provide a first mobile handset;

2. Provide a second handset, e.g., mobile, fixed, wired, other;

3. Transfer destination number information associated with a destination number (for a callee) within a first country code from the first mobile handset to a data network, which is coupled to a world wide network of computers;

4. Transfer caller number information associated with a caller number within a second country code, which is different from the first country code, from the first mobile handset to the data network;

5. Receive the destination information at a call server process, which is coupled to the world wide network of computers;

6. Receive the caller number information at the call server process;

7. Initiate a VoIP phone call using the destination number information from the server process to the second handset;

8. Connect the first mobile handset to the VoIP phone call to the second handset through the server process;

9. Exchange voice information between the first mobile handset and the second handset; and

10. Perform other steps, as desired.

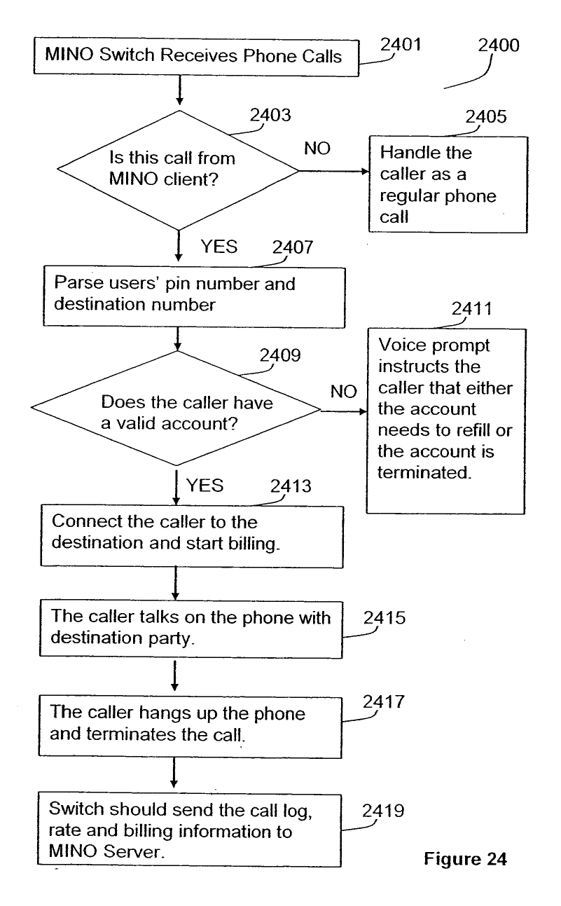

The above sequence of steps provides method according to an embodiment of the present invention. As shown, the method uses a combination of steps including a way of providing a connection through a VoIP network according to an embodiment of the present invention. Of course, other alternatives can also be provided where steps are added, one or more steps are removed, or one or more steps are provided in a different sequence without departing from the scope of the claims herein. Additionally, the various steps can be implemented using a computer code or codes in software, firmware, hardware, or any combination of these. Depending upon the embodiment, there can be other variations, modifications, and alternatives. Further details of the present method can be found throughout the present specification and more particularly according to FIG. 24 below.

In a specific embodiment, a method for using call back and/or call forward according to a specific embodiment is outlines as follows.

1. Provide a first mobile handset;

2. Provide a second handset, e.g., mobile, fixed, wired, other;

3. Transfer destination number information associated with a destination number (for a callee) within a first country code from the first mobile handset to a data network, which is coupled to a world wide network of computers;

4. Transfer caller number information associated with a caller number within a second country code, which is different from the first country code, from the first mobile handset to the data network;

5. Receive the destination information at a call server process, which is coupled to the world wide network of computers;

6. Receive the caller number information at the call server process;

7. Initiate a first VoIP phone call using the caller number information from the server process to the first mobile handset;

8. Initiate a second VoIP phone call using the destination number information from the server process to the second handset;

9. Connect the first VoIP phone call to the first mobile handset to the second VoIP phone call to the second handset through the server process;

10. Exchange voice information between the first mobile handset and the second handset; and

11. Perform other steps, as desired.

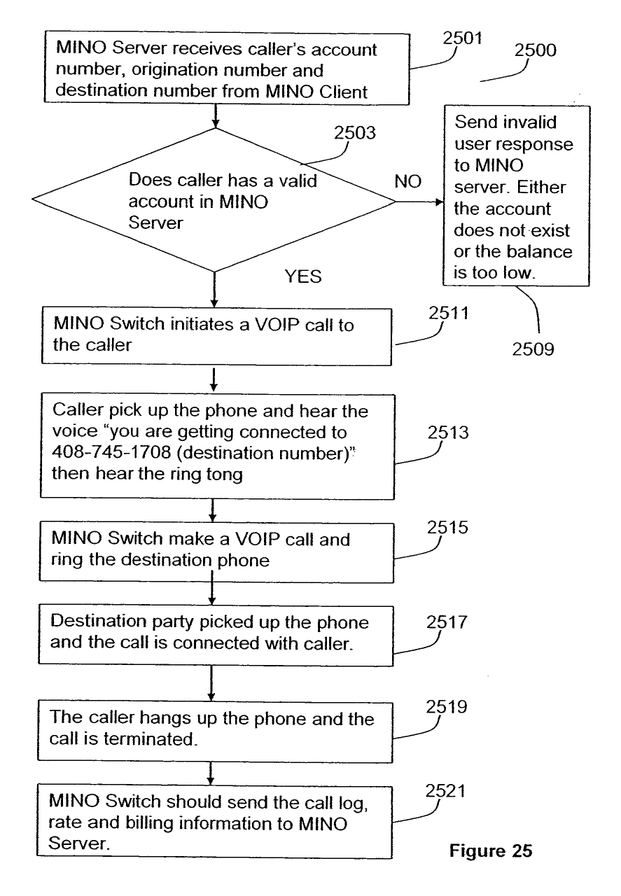

The above sequence of steps provides method according to an embodiment of the present invention. As shown, the method uses a combination of steps including a way of providing a connection through a VoIP network using call back and call forward according to an embodiment of the present invention. Of course, other alternatives can also be provided where steps are added, one or more steps are removed, or one or more steps are provided in a different sequence without departing from the scope of the claims herein. Additionally, the various steps can be implemented using a computer code or codes in software, firmware, hardware, or any combination of these. Depending upon the embodiment, there can be other variations, modifications, and alternatives. Further details of the present method can be found throughout the present specification and more particularly according to FIG. 25 below.

FIGS. 24 and 25 are simplified flow diagrams of methods for call back according to alternative embodiments of the present invention. These diagrams are merely examples, which should not unduly limit the scope of the claims herein. One of ordinary skill in the art would recognize many variations, modifications, and alternatives. As shown, the present invention provides a method 2400 for processing an multi-country international phone call, free from an international toll charge, using a voice over IP (VoIP) call from a first mobile handset to a second handset. In a specific embodiment, the method includes transferring destination number information associated with a destination number within a first country code (e.g., China, US, Japan, Taiwan, Philippines, Germany) from the first mobile handset to a data network, which is coupled to a world wide network of computers, e.g., Internet. In a preferred embodiment, the handset is coupled via cellular network (e.g., GSM, PCS) through a data network to the world wide network of computers. The method includes transferring caller number information associated with a caller number within a second country code from the first mobile handset to the data network. In a preferred embodiment, the first country code is different from the second country code.

As shown, the method includes receiving (step 2401) the destination information at a call server process, which is coupled to the world wide network of computers. In a preferred embodiment, the call server process can be any set of computer code or codes that have been provided in one or more memories to carry out the functionality described herein. The method also includes receiving (step 2401) the caller number information at the call server process.

Next, the method determines (step 2403) whether the call is from a valid caller, which is a subscriber or user of the call server process. If so, the method continues to the next step via the “YES” branch. Alternatively, the method continues via the “NO” branch to handle the call as a regular phone call, step 2405. In a preferred embodiment, the regular phone call is subjected to conventional international calling rates. Of course, there can be other variations, alternatives, and modifications.

In a specific embodiment, the method performs a parsing process, which derives certain information from the caller number information and/or destination number information. In a preferred embodiment, the method determines the caller's “pin number” and “destination number” as shown. The method determines whether the caller has a valid account, step 2409, according to a specific embodiment. If so, the method continues via the “YES” branch to the next step, 2413. Alternatively, the method continues via the “NO” branch to step 2411, which sends a voice prompt to instruct the caller with a message according to a specific embodiment. The message may be a prompt that instructs the caller that the account has been terminated, the account requires more funds, or others, including any combination of these according to a specific embodiment.

In a specific embodiment, the method initiates a VoIP phone call using the destination number information from the server process to the second handset. The method also connects (step 2413) the first mobile handset to the VoIP phone call to the second handset through the server process. The method also includes exchanging voice information (step 2415) between the first mobile handset and the second handset free from an international toll charge. The method continues until the caller and/or callee terminate the call (step 2417) according to a specific embodiment. Once the call has been terminated, the method sends (step 2419) information (e.g., call log, rate, billing information) to the server process or other desired location according to a specific embodiment.

The above sequence of steps provides method according to an embodiment of the present invention. As shown, the method uses a combination of steps including a way of providing a connection through a VoIP network using call forward according to an embodiment of the present invention. Of course, other alternatives can also be provided where steps are added, one or more steps are removed, or one or more steps are provided in a different sequence without departing from the scope of the claims herein. Additionally, the various steps can be implemented using a computer code or codes in software, firmware, hardware, or any combination of these. Depending upon the embodiment, there can be other variations, modifications, and alternatives.

Referring now to FIG. 25, the present invention provides a method 2500 for processing an multi-country international phone call, free from an international toll charge, using a voice over IP (VoIP) call from a first mobile handset to a second handset. In a specific embodiment, the method includes transferring destination number information associated with a destination number within a first country code (e.g., China, US, Japan, Taiwan, Philippines, Germany) from the first mobile handset to a data network, which is coupled to a world wide network of computers, e.g., Internet. In a preferred embodiment, the handset is coupled via cellular network (e.g., GSM, PCS) through a data network to the world wide network of computers. The method includes transferring caller number information associated with a caller number within a second country code from the first mobile handset to the data network. In a preferred embodiment, the first country code is different from the second country code.

As shown, the method includes receiving (step 2501) the destination information at a call server process, which is coupled to the world wide network of computers. In a preferred embodiment, the call server process can be any set of computer code or codes that have been provided in one or more memories to carry out the functionality described herein. The method also includes receiving (step 2501) the caller number information at the call server process. Depending upon the embodiment, the information can include other data such as account number, pin number, etc., and other like information.

Next, the method determines whether the call is from a valid caller (not shown), which is a subscriber or user of the call server process. If so, the method continues to the next step via a “YES” branch. Alternatively, the method continues via a “NO” branch. In a specific embodiment, the call is handled as a regular phone call. In a preferred embodiment, the regular phone call is subjected to conventional international calling rates. Of course, there can be other variations, alternatives, and modifications.

In a specific embodiment, the method performs a parsing process, which derives certain information from the caller number information and/or destination number information. In a preferred embodiment, the method determines the caller's “pin number” and “destination number” as shown. The method determines whether the caller has a valid account, step 2503, according to a specific embodiment. If so, the method continues via the “YES” branch to the next step, 2511. Alternatively, the method continues via the “NO” branch to step 2509, which sends a voice prompt to instruct the caller with a message according to a specific embodiment. The message may be a prompt that instructs the caller that the account has been terminated, the account requires more funds, or others, including any combination of these according to a specific embodiment.

In a specific embodiment, the method initiates (step 1511) a first VoIP phone call using the caller number information and the server process to call the first mobile handset from the server process. The method continues to connect the first mobile handset to the server process using the first VoIP connection according to a specific embodiment. In a specific embodiment, the caller can hear (step 2513) from the first mobile handset a message such as “You are getting connected to 408-745-1708 (which is the destination phone number).” Here, the method initiates (step 2515) a second VoIP phone call using the destination number information from the server process to the second handset according to specific embodiment. Next, the second handset picks up the call from the server process to connect the second handset to the server process according to a specific embodiment. The method also connects (step 1517) the first mobile handset to the VoIP phone call to the second handset through the server process. Of course, there can be other variations, modifications, and alternatives.

In a specific embodiment, the method also includes exchanging voice information between the first mobile handset and the second handset free from an international toll charge using the VoIP connection. The method continues until the caller and/or callee terminate the call (step 2519) according to a specific embodiment. Once the call has been terminated, the method sends (step 2521) information (e.g., call log, rate, billing information) to the server process or other desired location according to a specific embodiment.

The above sequence of steps provides method according to an embodiment of the present invention. As shown, the method uses a combination of steps including a way of providing a connection through a VoIP network using call back and call forward according to an embodiment of the present invention. Of course, other alternatives can also be provided where steps are added, one or more steps are removed, or one or more steps are provided in a different sequence without departing from the scope of the claims herein. Additionally, the various steps can be implemented using a computer code or codes in software, firmware, hardware, or any combination of these. Depending upon the embodiment, there can be other variations, modifications, and alternatives.

To prove the principle and operation of the present invention, we performed certain experiments using computer software, mobile handsets, and conventional hardware. These experiments are merely examples, which should not unduly limit the scope of the claims herein. One of ordinary skill in the art would recognize many variations, modifications, and alternatives. As shown below is certain pseudo computer code for implementing aspects of the present method for call back according to a specific embodiment. Such aspects include the call connection feature of the methods illustrated by way of FIG. 25 for example.

psudeo code for MINO ™ Server of Mino Holdings, Inc.

public class MINO Server
{

public InputStream commandListener // A channel to receive the message from

MINO client

public OutputStream commandSender //A channel to send response message to

MINO client

public SwitchHandler phoneSwtich; // A telecome switch that initiate and connect

the phone calls

public VoiceReponser voicePlayer; // A message voice player

// MINO server runs as a service and waits for the commands send from IP network.

public run( ) {

:
:
:

MINOCommand command = commandListener.ReceiveCommand( )
if (isUservalide(command.getCallerID( ) ) == false)

commandSender.sendCommand(“Account is invalid”);

/*if the user is valid continue*/
if ( commend instanceof Connect_Call_Command) // if the receive command is to

make a call

{

String originationNumber = commend. getOriginationNumber( );
String destinationNumber = commend. getDestinationNumber( );
/* call origination party */
Origination = phoneSwitch.call (originationNumber));
if ( Origination.isConnected == true ) { // origination party Pick up the

phone.

//voicePlayer plays message to Origination party
voicePlayer.play(“Please hold while we are connecting to your

destination”);

Destination = phoneSwitch.call (destinationNumber));
// origination party is reached.

if (Destination.isConnected == true ) {

phoneSwitch.join( Origination, Destination)

}else{

//voicePlayer plays message to Origination party
voicePlayer.play(Origination, “the number you dail

can not be reached please retry”);

}

}else {

//MINO server send the error message back to MINO

client.

MessageCommand msg =new

MessageCommand(“Origination number can not be reached please try again”);

commandSender.sendCommand(msg);

}//end of origination.isConnected }

//end of call command }

:
:
:

//end of run function

}
psudeo code for MINO Client
public class MINO Client
{

public InputStream commandListener // A channel to receive the message from

MINO server

public OutputStream commandSender //A channel to send response message to

MINO server

:
:
:

/*call function */
public call(String originationNumber, String destinationNumber)
{

Connect_Call_Command call = new Connect_Call_Command (

originationNumber, destinationNumber);

/*send connect call command to MINO server*/
commandSender.sendCommand( call );
MessageCommand msg = commandListener.getResponseMessage( );
msg.displayMessage( ); }

}

:
:
:

}

As shown above, the pseudo code is directed to connecting the two VoIP calls together according to a specific embodiment. Depending upon the embodiment, certain executable code may be implemented on a computer and/or computers in a server based process according to a specific embodiment. The code or codes may be provided in one or more memories of the computer and/or computers according to a specific embodiment. Of course, there can be other variations, modifications, and alternatives.

As used herein, the term ‘computer’ may include any processor-based or microprocessor-based system including systems using microcontrollers, digital signal processors (DSP), reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term ‘computer’. The computer system executes a set of instructions that are stored in one or more storage elements, in order to process input data. The storage elements may also hold data or other information as desired or needed. The storage element may be in the form of an information source or a physical memory element within the processing machine.

The set of instructions may include various commands that instruct the processing machine to perform specific operations such as the processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms ‘software’ and ‘firmware’ are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

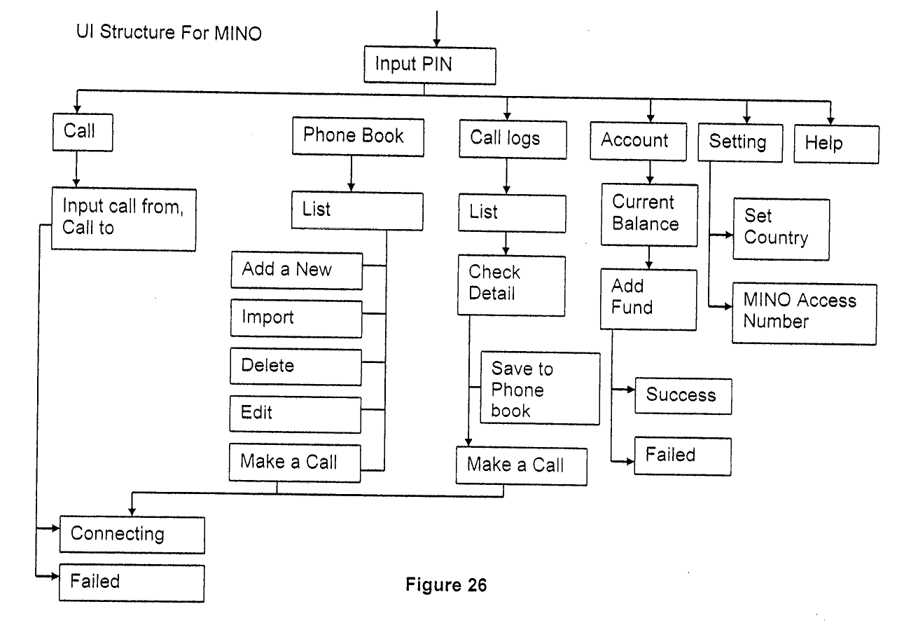

FIG. 26 is a simplified flow diagram of a user interface according to an embodiment of the present invention. This diagram is merely an illustration, which should not unduly limit the scope of the claims herein. One of ordinary skill in the art would recognize many variations, alternatives, and modifications.

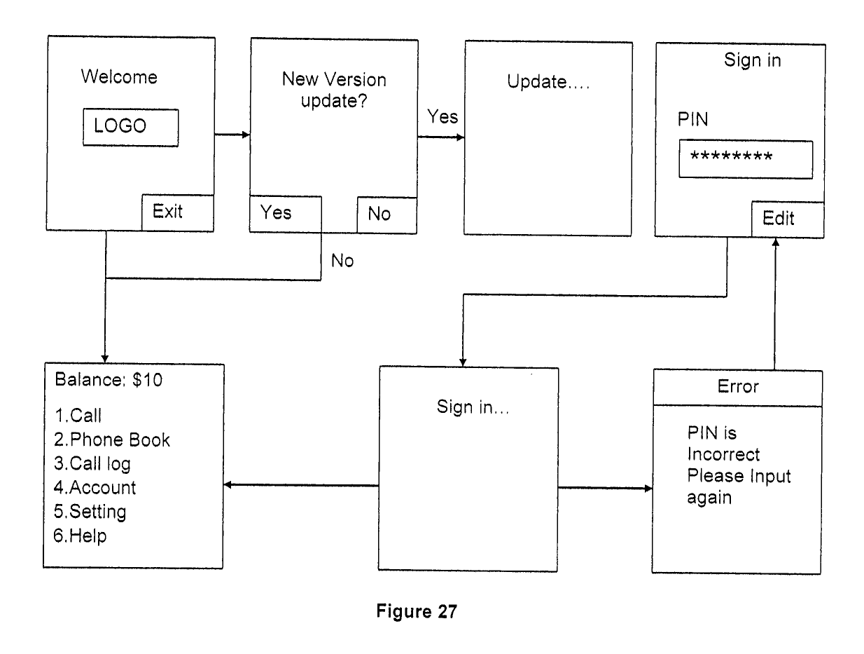

FIG. 27 is a simplified flow diagram illustrating a method for sign in and update for a user interface according to an embodiment of the present invention. This diagram is merely an illustration, which should not unduly limit the scope of the claims herein. One of ordinary skill in the art would recognize many variations, alternatives, and modifications.

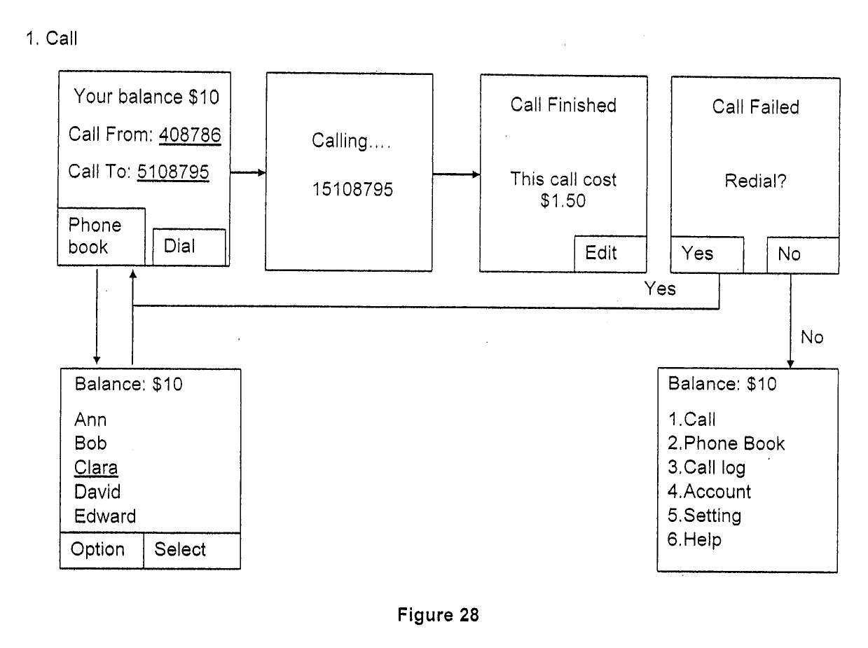

FIG. 28 is a simplified flow diagram illustrating a call method for a user interface according to an embodiment of the present invention. This diagram is merely an illustration, which should not unduly limit the scope of the claims herein. One of ordinary skill in the art would recognize many variations, alternatives, and modifications.

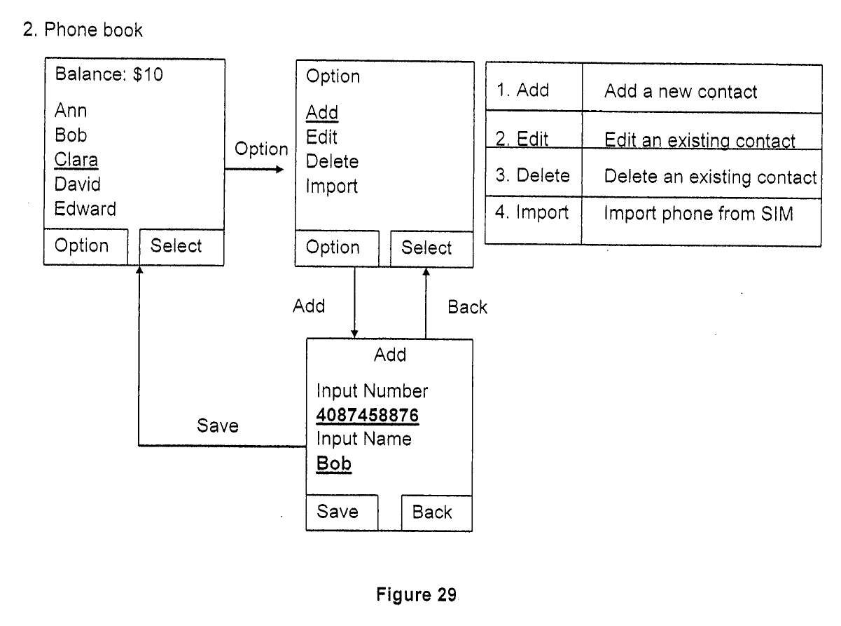

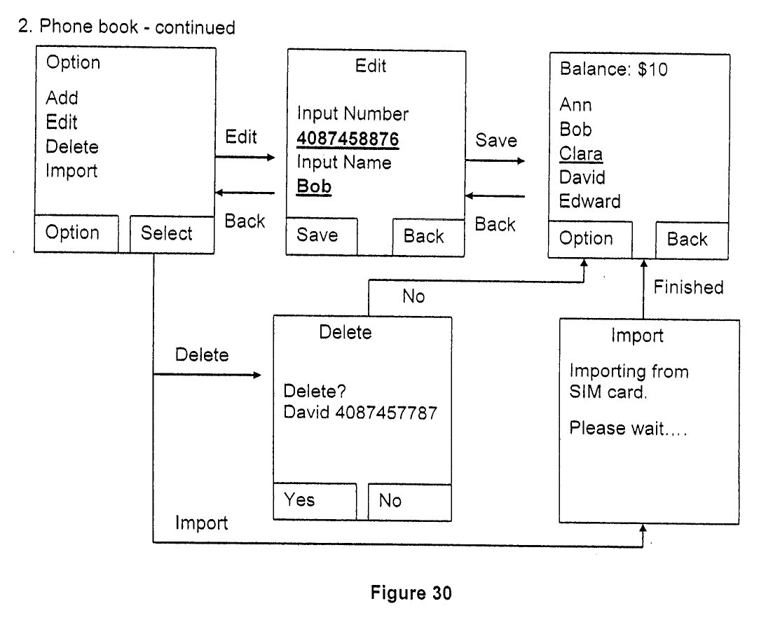

FIGS. 29 and 30 are simplified flow diagrams illustrating a phone book method for a user interface according to an embodiment of the present invention. These diagrams are merely illustrations, which should not unduly limit the scope of the claims herein. One of ordinary skill in the art would recognize many variations, alternatives, and modifications.

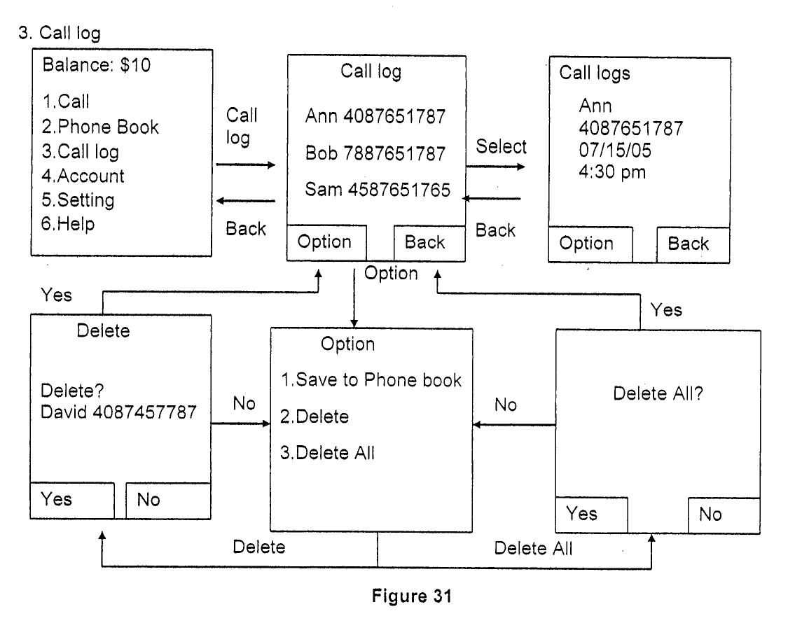

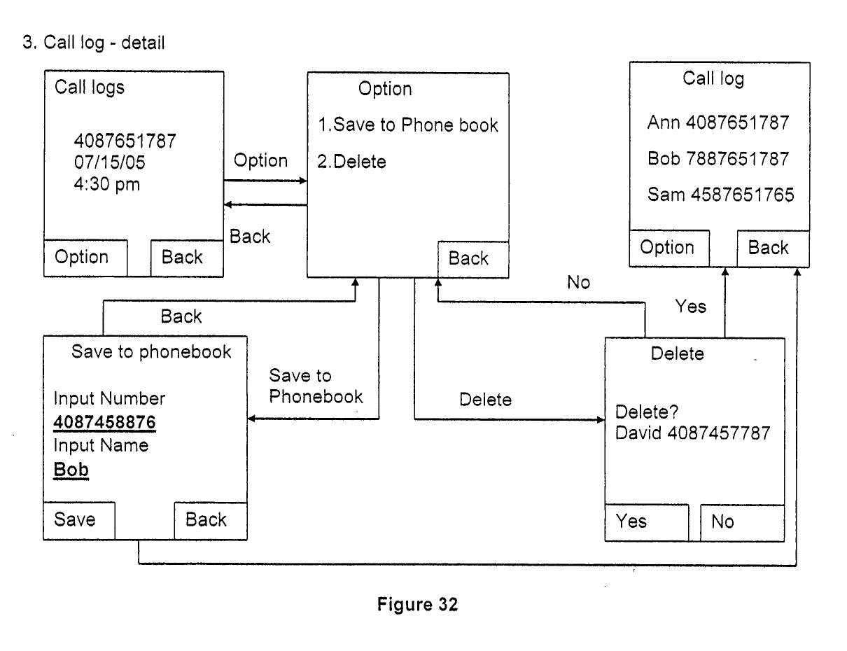

FIGS. 31 and 32 are simplified flow diagrams illustrating a call log method for a user interface according to an embodiment of the present invention. These diagrams are merely illustrations, which should not unduly limit the scope of the claims herein. One of ordinary skill in the art would recognize many variations, alternatives, and modifications.

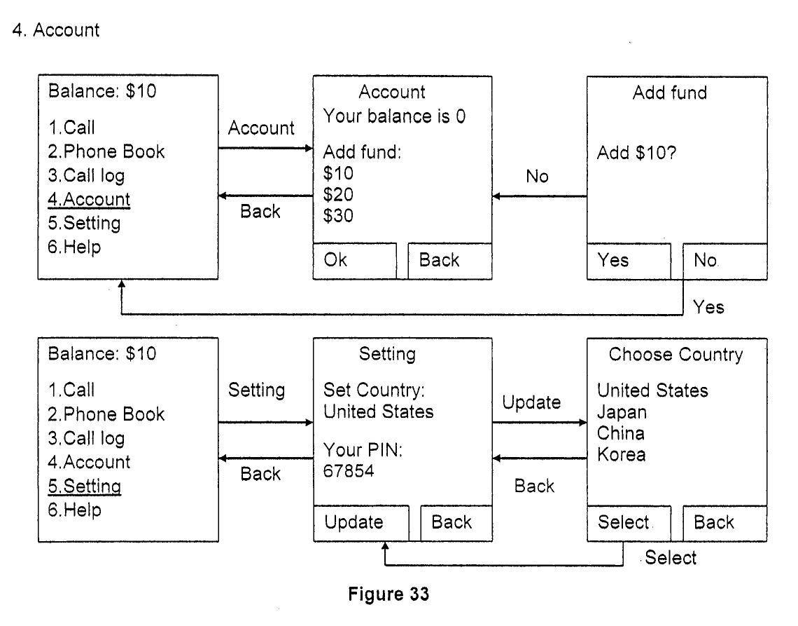

FIG. 33 are simplified flow diagrams illustrating an account status method and setting method for a user interface according to an embodiment of the present invention. This diagram is merely an illustration, which should not unduly limit the scope of the claims herein. One of ordinary skill in the art would recognize many variations, alternatives, and modifications.

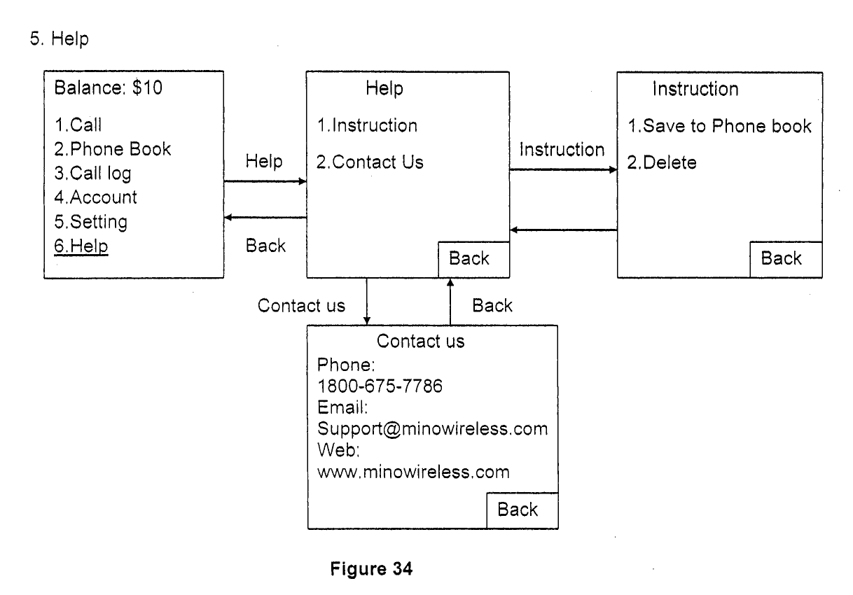

FIG. 34 is a simplified flow diagram illustrating a help method for a user interface according to an embodiment of the present invention. This diagram is merely an illustration, which should not unduly limit the scope of the claims herein. One of ordinary skill in the art would recognize many variations, alternatives, and modifications.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

It is also understood that the examples and embodiments described herein are for illustrative purposes only and that various modifications or changes in light thereof will be suggested to persons skilled in the art and are to be included within the spirit and purview of this application and scope of the appended claims

What is claim is:

1. A method for processing a voice over IP (VoIP) call from a first mobile handset to a second handset, the method comprising:
transferring destination number information associated with a destination number within a first country code from the first mobile handset to a data network, the data network being coupled to a world wide network of computers;
transferring caller number information associated with a caller number within a second country code from the first mobile handset to the data network, the first country code being different from the second country code;
receiving the destination information at a call server process, the call server process being coupled to the world wide network of computers;
receiving the caller number information at the call server process;
initiating a first VoIP phone call using the caller number information from the server process to the first mobile handset;
initiating a second VoIP phone call using the destination number information from the server process to the second handset;
connecting the first VoIP phone call to the first mobile handset to the second VoIP phone call to the second handset through the server process; and
exchanging voice information between the first mobile handset and the second handset.

2. The method of claim 2 further comprising monitoring a time period associated with the exchange of voice information once the connection between the first mobile handset and the second handset has been established.

3. The method of claim 2 further comprising monitoring a time period associated with the exchange of voice information once the connection between the first mobile handset and the second handset has been established; and associating a total cost with the time period by multiplying the time period with a calling rate for the connection between the first mobile handset and the second handset.

4. The method of claim 2 wherein the second handset is a selected from a client device, a wired handset, a cellular handset, or a paging unit.

5. The method of claim 2 wherein the connecting is a bridging process.

6. The method of claim 2 wherein the first VoIP call is a call back process, the call back process being substantially less in costs than a call forward process from the first mobile handset to the second handset using the destination phone number.

7. The method of claim 2 wherein the first VoIP call is substantially free from an international toll charge associated with an international phone call from the first mobile handset to the second handset.

8. The method of claim 2 wherein the data network comprises an IP network.

9. The method of claim 2 wherein the IP network comprises a wired portion and a cellular portion, the cellular portion being coupled to the first mobile handset.

10. A system for processing a voice over IP (VoIP) call from a first mobile handset to a second handset, the system comprising one or more computer readable memories, the one or more computer readable memories including:
one or more codes directed to receiving destination number information associated with a destination number within a first country code from a data network coupled to the first mobile handset, the data network being coupled to a world wide network of computers;
one or more codes directed to receiving caller number information associated with a caller number within a second country code from the data network coupled to the first mobile handset, the first country code being different from the second country code;
one or more codes directed to processing the destination information at a call server process, the call server process being coupled to the world wide network of computers;
one or more codes directed to processing the caller number information at the call server process;
one or more codes directed to initiating a first VoIP phone call using the caller number information from the server process to the first mobile handset;
one or more codes directed to initiating a second VoIP phone call using the destination number information from the server process to the second handset; and
one or codes directed to connecting the first VoIP phone call to the first mobile handset to the second VoIP phone call to the second handset through the server process.

11. The system of claim 10 further comprising one or more codes directed to monitoring a time period associated with an exchange of voice information between the first mobile handset and the second handset.

12. A method for processing an multi-country international phone call, free from an international toll charge, using a voice over IP (VoIP) call from a first mobile handset to a second handset, the method comprising:
transferring destination number information associated with a destination number within a first country code from the first mobile handset to a data network, the data network being coupled to a world wide network of computers;
transferring caller number information associated with a caller number within a second country code from the first mobile handset to the data network, the first country code being different from the second country code;
receiving the destination information at a call server process, the call server process being coupled to the world wide network of computers;
receiving the caller number information at the call server process;
initiating a first VoIP phone call using the caller number information from the server process to the first any hand set or client;
initiating a second VoIP phone call using the destination number information from the server process to the second handset;
connecting the first VoIP phone call to the first mobile handset to the second VoIP phone call to the second handset through the server process; and
exchanging voice information between the first mobile handset and the second handset free from an international toll charge.
